(19) United States
(12) Patent Application Publication
(10) Pub. No.: US 2009/0165039 A1
(43) Pub. Date: Jun. 25, 2009

(54) METHOD AND APPARATUS FOR ENABLING VIEWERS OF TELEVISION TO ENTER INTO CONTACT WITH A SOURCE OF AN ADVERTISED PRODUCT OR SERVICE

(76) Inventors: Sieark Joseph Soo, Orleans (CA); Eric John Wolf, Stillsvile (CA); Sean MacLean Murray, Ottawa (CA); James Francis Fagan, Ottawa (CA); Iiya Kalnish, Woodbridge (CA)

Correspondence Address: SMART & BIGGAR, 1000 DE LA GAUCHETIERE ST. W., SUITE 3300, MONTREAL, QC, H3B 4W5, CA

(21) Appl. No.: 11/571,008

(22) PCT Filed: Dec. 21, 2005
(86) PCT No.: PCT/CA05/01943

§ 371 Date: Oct. 22, 2008

(51) Int. Cl. H04N 7/025; G06F 17/30; H04N 7/173

(52) U.S. Cl. 725/34; 707/3; 725/35; 725/106; 707/E17.014; 707/E17.044; 370/352

(57) ABSTRACT

A method comprises releasing to at least one television service subscriber a content stream conveying at least one information element deemed to be of potential interest to a multi-subscriber audience that includes the at least one television service subscriber; receiving from a particular one of the at least one television service subscriber an indication of a selection of a particular one of the at least one information element; determining a telephone number associated with the particular television service subscriber; determining a telephone number associated with the particular information element; establishing a first telephony leg on a basis of the telephone number associated with the particular information element; establishing a second telephony leg on a basis of the telephone number associated with the particular television service subscriber; and joining the first and second telephony legs to form an end-to-end telephony link for the particular television service subscriber.

### FIELD OF THE INVENTION

The present invention relates generally to television distribution systems and, in particular, to a method and apparatus for enabling viewers of a television program to enter into contact with a source of an advertised product or service.

### BACKGROUND

When advertising certain types of products or services on television, advertisers aim to entice potential customers to enter into contact with a source of the product or service being offered. To this end, a telephone number may be displayed in association with an advertisement. The viewer of the advertisement may note the telephone number and dial it either immediately or at a later time (e.g., once the program he or she is watching is over) in order to enter into contact with the source of the advertised product or service.

However, advertisers are not immune to the pressures of cost reduction. Hence, when broadcasting to viewers across a set of area codes or time zones, the provision of a single telephone number local to one area code will require viewers who are outside this area code to pay long-distance charges when contacting the advertiser. Alternatively, the advertiser may lease a set of numbers in various area codes and display all of these in a carousel, as is often done for telethons. This solution tends to clutter the television screen and is not considered satisfactory, as it relies on the viewer to actively determine the number to be dialed. Finally, the leasing of a toll-free number is a possible solution, although it incurs additional costs that are not always justifiable.

Thus, there exists a need in the industry for a low-cost improvement to the manner in which viewers can be enticed to enter into contact with the source of an advertised product or service.

### SUMMARY OF THE INVENTION

Due to recent technological advances, television has become a two-way medium, allowing viewers to communicate limited amounts of information back to a content source. By exploiting this feature, and the fact that virtually every household has a telephone of some sort, one can overcome certain limitations of conventional advertising techniques.

According to a first broad aspect, therefore, the present invention seeks to provide a method. The method comprises releasing to at least one television service subscriber a content stream conveying at least one information element deemed to be of potential interest to a multi-subscriber audience that includes the at least one television service subscriber; receiving from a particular one of the at least one television service subscriber an indication of a selection of a particular one of the at least one information element; determining a telephone number associated with the particular television service subscriber; determining a telephone number associated with the particular information element; establishing a first telephony leg on a basis of the telephone number associated with the particular information element; establishing a second telephony leg on a basis of the telephone number associated with the particular television service subscriber; and joining the first and second telephony legs to form an end-to-end telephony link for the particular television service subscriber.

According to a second broad aspect, therefore, the present invention seeks to provide a system. A system comprises a transmission module operable for releasing to at least one television service subscriber a content stream conveying at least one information element deemed to be of potential interest to a multi-subscriber audience that includes the at least one television service subscriber. The system comprises a return path module, which is operable for: receiving from a particular one of the at least one television service subscriber an indication of a selection of a particular one of the at least one information element; determining a telephone number associated with the particular television service subscriber; and determining a telephone number associated with the particular information element. The system further comprises a call control module operable for establishing a first telephony leg on a basis of the telephone number associated with the particular information element; and establishing a second telephony leg on a basis of the telephone number associated with the particular television service subscriber. Finally, the system also comprises joining the first and second telephony legs to form an end-to-end telephony link for the particular television service subscriber.

According to a third broad aspect, therefore, the present invention seeks to provide a system a computer-readable medium comprising computer-readable program code which, when interpreted by a computing apparatus, causes the computing apparatus to execute a method. The computer-readable program code comprises first computer-readable program code for causing the computing apparatus to release to at least one television service subscriber a content stream conveying at least one information element deemed to be of potential interest to a multi-subscriber audience that includes the at least one television service subscriber; second computer-readable program code for causing the computing apparatus to await receipt from a particular one of the at least one television service subscriber of an indication of a selection of a particular one of the at least one information element; third computer-readable program code for causing the computing apparatus to determine a telephone number associated with the particular television service subscriber; fourth computer-readable program code for causing the computing apparatus to determine a telephone number associated with the particular information element; fifth computer-readable program code for causing the computing apparatus to establish a first telephony leg on a basis of the telephone number associated with the particular information element; sixth computer-readable program code for causing the computing apparatus to establish a second telephony leg on a basis of the telephone number associated with the particular television service subscriber; and seventh computer-readable program code for causing the computing apparatus to join the first and second telephony legs to form an end-to-end telephony link for the particular television service subscriber.

According to a fourth broad aspect, therefore, the present invention seeks to provide a set-top box registered to a television service subscriber. The set-top box comprises: a first interface adapted to receive from a content provider a content stream conveying at least one information element deemed to be of potential interest to a multi-subscriber audience that includes the television service subscriber; a second interface adapted to receive a selection by the television service subscriber of a particular one of the at least one information element; and a processing unit operable for effecting a transmission to the content provider of an indication of said selection, said transmission being instrumental in causing a telephone call to be placed to a telephony device. According to this aspect, when the telephone call is answered by a user of the telephony device, the user is placed in communication with an information source associated with the particular information element.

According to a fifth broad aspect, therefore, the present invention seeks to provide a method for execution at a set-top box registered to a television service subscriber. The method comprises receiving from a content provider a content stream conveying at least one information element deemed to be of potential interest to a multi-subscriber audience that includes the television service subscriber; receiving a selection by the television service subscriber of a particular one of the at least one information element; and effecting a transmission to the content provider of an indication of said selection, said transmission being instrumental in causing a telephone call to be placed to a telephony device. According to this aspect, when the telephone call is answered by a user of the telephony device, the user is placed in communication with an information source associated with the particular information element.

### BRIEF DESCRIPTION OF THE DRAWINGS

FIG. 1 shows a block diagram of a system in which there is depicted a content provider that delivers television programming to a subscriber's set-top box over a television distribution network;

FIG. 2 is an example of a database used by the content provider to determine a telephone number at which to reach the subscriber in response to a signal received from the subscriber identifying the subscriber's set-top box;

FIG. 3A illustrates a flow of signals among the entities of FIG. 1, in the case where an advertisement is transmitted by the content provider and selected by the subscriber;

FIG. 3B shows establishment of an end-to-end telephony link between the subscriber and a source entity for the advertisement;

FIG. 4 is a variant of FIG. 3A, in which related source entities for the same advertisement are reachable via separate telephone numbers;

FIG. 5A is another variant of FIG. 3A, in which advertisements are associated with advertisement codes;

FIG. 5B shows an advertisement index that maps advertisement codes to contact telephone numbers of source entities for those advertisements;

FIG. 6A is yet another variant of FIG. 3A, in which the set-top box records the date, time and channel of a subscriber's selection of an advertisement; and

FIG. 6B shows an advertisement schedule.

### DETAILED DESCRIPTION OF EMBODIMENTS

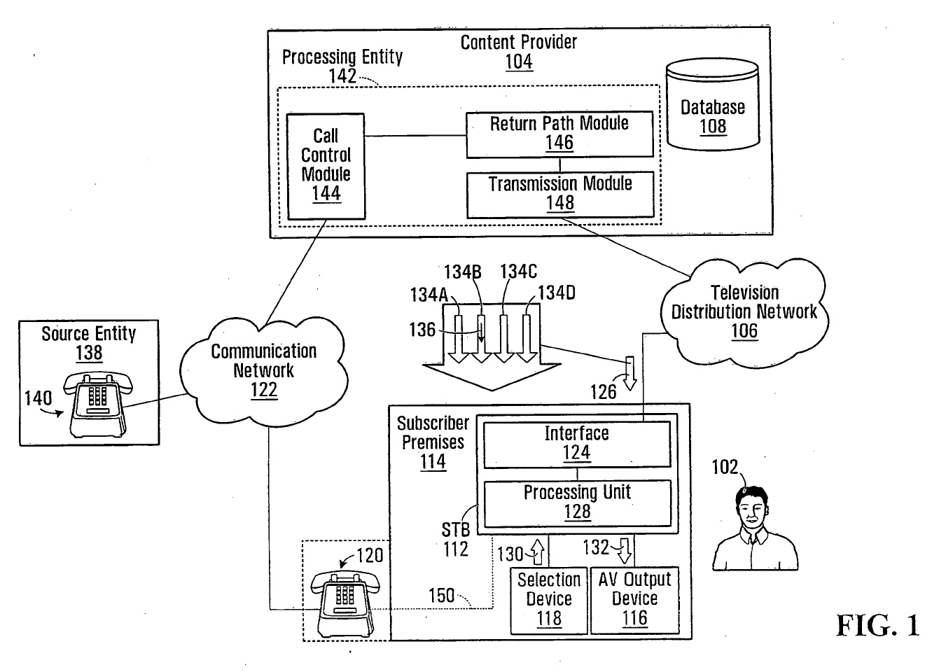

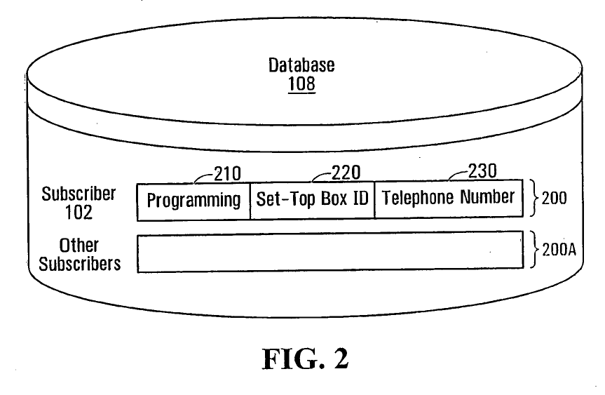

With reference to FIG. 1, there is shown an architecture in which a subscriber to a television service (hereinafter referred to as a “television service subscriber” or simply as a “subscriber” 102) receives television programming from a content provider 104 over a television distribution network 106. The specific television programming that the subscriber 102 wishes to be able to view can be selected by the subscriber 102 from a set of channel packages, feature packages and the like that may be offered by the content provider 104. A database 108 at the content provider 104 may store an association between the subscriber 102 and data representative of the selected television programming for the subscriber 102. Specifically, in a non-limiting example embodiment illustrated in FIG. 2, the database 108 can comprise a record 200 for the subscriber 102. The record 200 contains a field 210 that stores data representative of the selected television programming for the subscriber 102. Similar records 200A may exist for other subscribers (not shown).

Suitable television distribution networks 106 that enable the above-mentioned customized viewing possibilities include satellite, IPTV, xDSL and cable systems. In each of these types of distribution networks 106, the subscriber 102 is provided with a set-top box (hereinafter STB) 112 installed at a subscriber premises 114. In some cases, the STB 112 can be alternatively and equivalently referred to as a receiver device, modem, residential gateway, network interface device, etc. The subscriber premises 114 further comprises an audio-visual output device 116 (e.g., a television set) and a selection device 118 (e.g., a remote control).

The STB 112 can have a unique identifier, such as a serial number, MAC address or IP address, by way of non-limiting example. The database 108 at the content provider 104 stores an association between the subscriber 102 and the identifier of the STB 112. Specifically, the record 200 for the subscriber 102 contains a field 220 that stores the identifier (ID) of the STB 112. The same applies to the records 200A for the other subscribers (not shown).

Also provided in the architecture of FIG. 1 is a telephony device 120, which is reachable via a communication network 122 by dialing a “subscriber telephone number”. The database 108 at the content provider 104 stores an association between the subscriber 102 and the subscriber telephone number. Specifically, the record 200 for the subscriber 102 contains an additional field 230 that stores the subscriber telephone number. The same applies to the records 200A for the other subscribers (not shown).

It should be appreciated that the subscriber telephone number represents a telephone number where the subscriber desires to be reached after signaling his or her interest in an advertised product or service. Thus, if the subscriber wishes to be contacted at home, the telephony device 120 may reside at the subscriber premises 114 and may be implemented as a POTS phone, a VoIP phone or a soft phone (i.e., a computer equipped with telephony software). Alternatively, when the subscriber wishes to be contacted on the move, the telephony device 120 may reside with the subscriber (i.e., not necessarily at the subscriber premises 114) and may be implemented as a cellular phone or other mobile communication device (e.g., a telephony-enabled personal digital assistant).

The subscriber telephone number can be specified by the subscriber 102 during a registration phase, whereby the subscriber 102 interacts with the content provider 104 in any desired way, such as by phoning or via the Internet. Also, the subscriber telephone number need not be fixed for all time but rather can be modified by the subscriber 102 as desired. Modification of the subscriber telephone number may be achieved in a variety of ways, including but not limited to by way of an interactive voice response (IVR) system or a web site.

The STB 112 comprises an interface 124 to the television distribution network 106. The interface 124 may differ according to the nature of the television distribution network 106, i.e., depending on whether it is a satellite, IPTV, xDSL or cable system. In each case, however, the interface 124 comprises suitable circuitry, software and/or control logic for receiving a signal 126 from the content provider 104. The STB 112 also comprises a processing unit 128 for performing various functions to be described herein below. The processing unit 128 may be implemented in software, hardware, control logic or a combination thereof.

In the case where the television distribution network 106 is a satellite system, an xDSL system or a cable system, the signal 126 received at the STB 112 can be a broadcast signal carrying a plurality of content streams 134A, 134B, 134C, 134D that collectively satisfy the viewing needs of all subscribers (including the subscriber 102). However, the processing unit 128 in each given STB 112 will only be authorized to access a limited portion of the received signal, that is to say, a portion which corresponds to the selected television programming for the subscriber associated with the given STB. For example, in the case of subscriber 102, the portion in question may include a limited number of content streams corresponding to a channel package subscribed to by the subscriber 102. Some of the content streams in the channel package may be television content streams, while others of the content streams may be data content streams conveying, for example, interactive TV (iTV) applications for download and installation on the STB 112.

Continuing with the example where the television distribution network 106 is a satellite system, an xDSL system or a cable system, the processing unit 128 is operable for selecting, from the limited number of television content streams and data content streams in the received signal 126, a specific content stream to be placed into a format suitable for handling by the audio-visual output device 116. To this end, the processing unit 128 is responsive to a signal 130 received from the selection device 118 as a result of interaction between the subscriber 102 and the selection device 118. For example, the subscriber 102 may dynamically select the specific content stream using the selection device 118. Upon receipt of this selection from the selection device 118, the processing unit 128 extracts the specific content stream from the limited number of television content streams and data content streams in the portion of the received signal 126.

In the case where the television distribution network 106 is an IPTV system, the signal 126 received at the STB 112 can similarly be a broadcast signal carrying all the content streams needed to satisfy the viewing needs of all subscribers. Alternatively, in an IPTV system, it is contemplated that the signal 126 received at the STB 112 can comprise a signal that is more customized to the individual needs of the subscriber 102.

In a first non-limiting example applicable to an IPTV system, the signal in question may include a set of content streams (e.g., television content streams and data content streams) that correspond to the aforementioned limited number of television content streams and data content streams, which would be pre-selected by the content provider 104 based on the television programming for the subscriber 102. Here, the processing unit 128 in the STB 112 is operable for selecting, from the limited number of television content streams and data content streams, a specific content stream to be placed into a format suitable for handling by the audio-visual output device 116. As mentioned above, the processing unit 128 is responsive to the signal 130 submitted by the subscriber 102 via the selection device 118, by virtue of which the subscriber 102 may dynamically select the specific content stream.

In a second non-limiting example applicable to an IPTV system, the signal released by the content provider 104 towards the subscriber 102 is changed on the fly, and is limited to comprising the specific content stream that has actually been selected by the subscriber 102, in addition to possibly an auxiliary content stream that may be part of the subscriber's channel package but which was not explicitly selected by the subscriber using the selection device 118. The requisite dynamic channel changing at the content provider 104 is achieved by rendering the processing unit 128 operable to capture the subscriber's selections and to return them to the content provider 104 in a reverse direction of communication. Based on the subscriber's selections, the content provider determines the specific content stream requested by the subscriber 102 and sends the specific content stream to the STB 112, possibly bundled with an auxiliary content stream. In a non-limiting example, the auxiliary content stream may be a data content stream containing an iTV application that may be required to support certain features being subscribed to by the subscriber 102.

Assume now that for the purposes of the present non-limiting example, the specific content stream is a specific television content stream 134B. With continued reference to FIG. 1, the specific television content stream 134B may include a substream 136 that carries a television show/movie. Regardless of the type of television distribution network 106 (e.g., satellite, cable, xDSL or IPTV), the processing unit 128 at the STB 112 converts the substream 136 of the specific television content stream 134B into an audio-visual signal 132, which is supplied to the audio-visual output device 116 for conveyance of the television show to the subscriber 102.

Those skilled in the art will appreciate that the substream 136 of the specific television content stream 134B may include information that is deemed to be of potential interest to a multi-subscriber audience that includes the subscriber 102. Non-limiting examples of information falling into this category include:
a commercial advertisement for a product or service, which can occur between segments of the television show/movie carried by the substream 136 of the specific television content stream 134B;
the television show/movie itself, containing embedded product or service placements (“plugs”) at strategic moments;
the television show itself, when aimed specifically at shoppers (e.g., a home shopping channel, whose raison d'être is to provide viewers with continuous opportunities to purchase a product or service);
a solicitation for a charitable contribution;
a public service announcement, inviting viewers to speak to someone at the other end of a kids help line, suicide prevention hotline, domestic violence sanctuary hotline, crime stoppers hotline, etc.;
an announcement made by a fan club, inviting viewers to speak to a representative of the fan club;
a survey, poll or vote, where a viewer is asked to indicate a preference (such as a singer, musician, etc.) by dialing a specific telephone associated with his or her preference;
a survey, poll or vote, requiring confirmation of viewer input via a telephone;
an announcement for a call-in talk show or debate, inviting viewers to speak to the show's host or participate in the debate;
etc.

Further examples of what may constitute information that is deemed to be of potential interest to a multi-subscriber audience that includes the subscriber 102 will be apparent to those of skill in the art.

For the sole purpose of simplifying the present description, only one example of information that is deemed to be of potential interest to a multi-subscriber audience that includes the subscriber 102 namely, an advertisement for a product or service, will be used herein below to continue to describe the present invention. Nevertheless, it is expected that those skilled in the art will readily appreciate how the teachings herein can be applied to the other aforementioned examples of information that is deemed to be of potential interest to a multi-subscriber audience, as well as to other examples not explicitly listed above.

With this in mind, and in accordance with an embodiment of the present invention, some of the advertisements for a product or service may be associated with a contact telephone number, which may be the telephone number of a source entity (such as a merchant) for the advertised product or service. One example of a source entity is illustrated by the numeral 138. Located at the source entity 138 is a communication device 140 that is reachable via the communication network 122 by dialing a specific contact telephone number assigned to the source entity 138.

The communication network 122 enables basic telephony and possibly other services to be provided to the source entity 138 and the subscriber 102. The communication network 122 may be embodied as a wireless network, a data network (such as the Internet) capable of handling VoIP calls, the public switched telephone network (PSTN) or a combination thereof.

In the case where the communication device 140 is reachable via a portion of the communication network 122 that is part of a wireless network or a data network capable of handling VoIP calls, the contact telephone number assigned to the source entity 138 may uniquely identify the communication device 140 regardless of its physical location. Similarly, where the telephony device 120 is reachable via a portion of the communication network 122 that is part of a wireless network or a data network capable of handling VoIP calls, the subscriber telephone number may uniquely identify the telephony device 120 at the subscriber premises 114 regardless of its physical location.

In the case where the communication device 140 is connected to a physical link of the communication network 122 that is part of the PSTN, the contact telephone number assigned to the source entity 138 may uniquely identify the physical link to which the communication device 140 (and possibly other communication devices not shown) at the source entity 138 may be connected. Similarly, where the telephony device 120 is connected to a physical link of the communication network 122 that is part of the PSTN, the subscriber telephone number may uniquely identify the physical link to which the telephony device 120 (and possibly other telephony devices not shown) may be connected.

The communication network 122 is further coupled to a processing entity 142 at the content provider 104. The processing entity 142, which has access to the aforementioned database 108, can include a call control module 144, a transmission module 148 and a return path module 146. Those skilled in the art will appreciate that certain portions of the processing entity 142 may be implemented using hardware, software, control logic or a combination thereof. Also, it should be appreciated that the processing entity 142 may include a number of other components used for purposes other than the purpose of the present invention.

In one embodiment of the present invention, the call control module 144 can comprise call processing hardware. In some embodiments of the present invention, the call processing hardware can comprise an HP Proliant DL380 G2 Telephony Server manufactured by Hewlett-Packard Company of 3000 Hanover St., Palo Alto, Calif., USA, and 2 NMS CG6000 card manufactured by NMS Communications of 100 Crossing Blvd., Framingham, Mass., USA.

The call control module 144 can further comprise call processing logic, which is responsible for controlling the call processing hardware and for exchanging signalling information with the communication network 122. It should be understood that any suitable call processing logic can be employed for the purposes of this invention and as one skilled in the art will appreciate, the call processing logic will depend on the type of the signalling information and the type of processing required. For example, the call processing logic can comprise a Ubiquity Application Server—available from Ubiquity of 515 Legget Dr., Suite 400, Ottawa, Ontario, Canada—which is capable of processing SIP-based signalling information. In other embodiments, the call processing logic can comprise a Java-based software application for processing SS7-based signalling information.

It should be recognized that the call control module 144 can comprise additional hardware, firmware and/or software components. For instance, in some embodiments of the present invention, the call control module 144 can further comprise a media server, which can be used for DTMF signal detection and the like.

The transmission module 148 can be co-located with the call control module 144 or it can be located elsewhere. In one specific non-limiting example, the transmission module 148 can comprise an HP Proliant BL20p G3 Blade Server manufactured by Hewlett-Packard Company.

The transmission module 148 is operable to perform a number of functions, such as compiling content streams from various content sources (not shown), multiplexing the compiled content streams, encoding the multiplexed content streams for transmission and transmitting the encoded content streams to a number of STBs including the STB 112. Also, the transmission module 148 performs a variety of administrative functions such as billing, maintaining customer profiles and maintaining channel line-ups.

Depending on the nature of the television distribution network 106, the return path module 146 can be co-located with the call control module 144 and/or the transmission module 148, or it can be located elsewhere. The return path module 146 is operable to cause the call control module 144 to initiate outgoing calls over the communication network 122 and, more specifically, to initiate two call legs and then to bridge them in a back-to-back fashion, analogous to establishing a three-way conference and hanging up. Control of this activity of the call control module 144 is performed on the basis of subscriber input received from a number of STBs including the STB 112 via a respective return path to the return path module 146.

The manner in which the return path is established depends on the nature of the television distribution network 106. In the case where the television distribution network 106 is a cable system, an xDSL system or an IPTV system, a point-to-point link between the content provider 104 and the STB 112 is available for distribution of the signal 126. This same point-to-point link can be used to establish the return path to the content provider 104. In the case where the television distribution network 106 is a satellite system, there is no point-to-point link between the content provider 104 and the subscriber premises 114. Here, the solution is to connect the STB 112 to the telephony device 120 at the subscriber premises 114. This is shown by a dashed line numbered 150 in FIG. 1. When subscriber input needs to be sent to the content provider 104, the STB 112 can dial into the content provider 104 via the communication network 122, thereby establishing a return path to the return path module 146, possibly via the call control module 144.

It is recalled that the use of a return path was briefly described above in connection with relaying to the content provider 104 the subscriber's selection of a specific content stream, in the case where the television distribution network was an IPTV system with a point-to-point IPTV link between the content provider 104 and the STB 112. In greater detail, what is happening is that the STB 112 captures the subscriber's dynamic selection of the specific content stream and sends it to the return path module 146 over the point-to-point IPTV link. Upon receipt of the subscriber's selection, the return path module 146 isolates the specific content stream and controls the transmission module 148 to send the corresponding signal to the STB 112. The transmission module 148 may decide that an auxiliary content stream (such as a data content stream) may need to accompany the specific content stream.

Additional types of subscriber input that may be conveyed to the return path module 146 at the content provider 104 include indications of the subscriber's selection of an advertisement appearing in a given television content stream. The manner in which this type of subscriber input can be obtained by the STB 112, as well as the impact that this type of subscriber input has on the functioning of the processing entity 142, will become apparent from the below description, which applies regardless of the nature of the television distribution network 106 (e.g., satellite, cable, xDSL or IPTV).

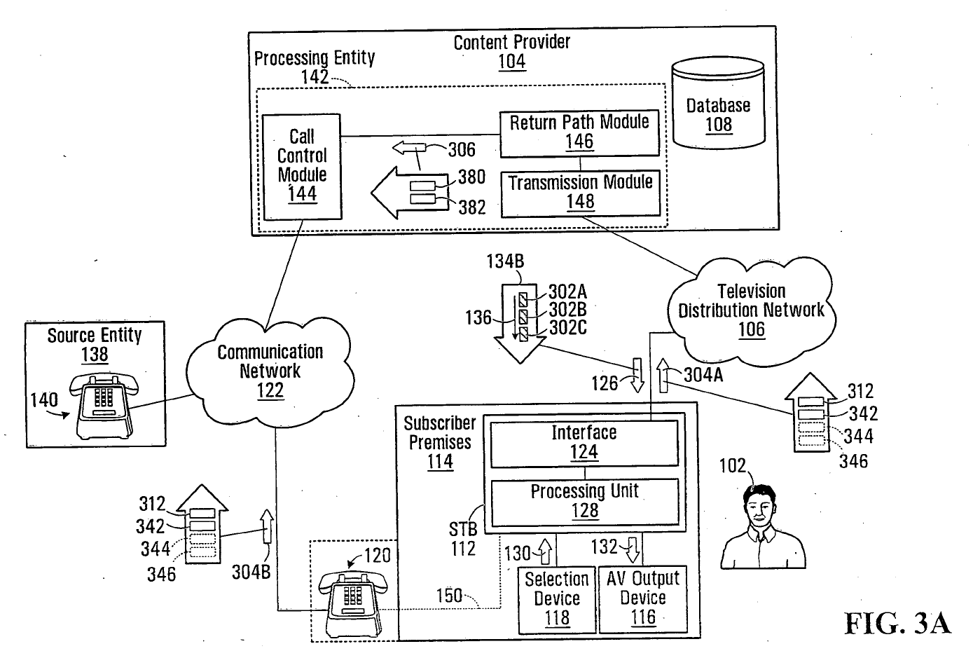

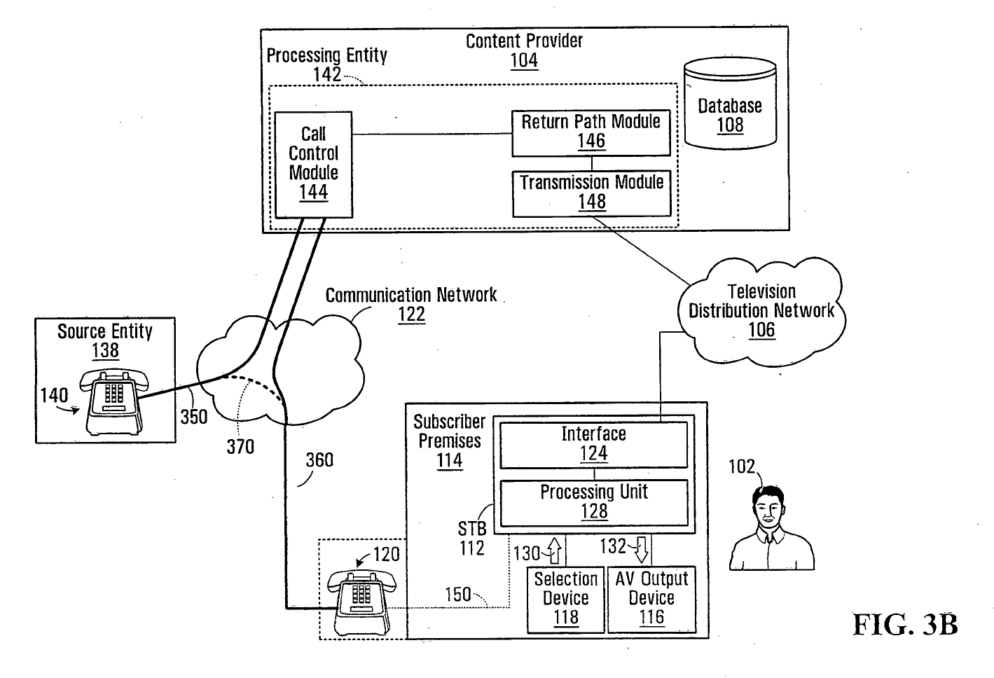

Reference is now made to FIG. 3A. Recalling the earlier assumption that the specific content stream is the specific television content stream 134B including the substream 136 carrying a television show, and further recalling that the television show may include advertisements, specific non-limiting embodiments of the present invention contemplate that certain advertisements appearing in the specific television content stream 134B will be associated with so-called “data elements” 302A, 302B, 302C. The data elements 302A, 302B, 302C can be inserted into the specific television content stream 134B, while other data elements (not shown) associated with advertisements appearing in other television content streams can be inserted into those other television content streams. Persons skilled in the art will appreciate that the manner in which the data elements 302A, 302B, 302C are made to coexist with the substream 136 within the specific television content stream 134B is not particularly limiting. For example, the data elements 302A, 302B, 302C may be hidden tagged identifiers within the substream 136.

Insertion of the data elements 302A, 302B, 302C into the specific television content stream 134B, as well as insertion of other data elements into other television content streams, is performed by the transmission module 148. Ideally, the transmission module 148 ensures that insertion of the data element associated with a given advertisement appearing on a given television content stream is synchronized with appearance of the given advertisement within the given television content stream.

In a first specific example, each of the data elements 302A, 302B, 302C appealing in the specific television content stream 134B comprises the contact telephone number of a respective source entity for an advertised product or service. For example, let data element 302A comprise the contact telephone number assigned to the source entity 138. Other ones of the data elements 302B, 302C may comprise contact telephone numbers assigned to other source entities (not shown). Similarly, other data elements (not shown) may appear in other ones of the content streams 134A, 134C, 134D that are television content streams.

At the STB 112, the specific television content stream 134B (which contains the substream 136 and the data elements 302A, 302B, 302C) is processed as follows. Firstly, as has already been described, the processing unit 128 converts the substream 136 of the specific television content stream 134B carrying the television show into the aforementioned audio-visual signal 132, which is supplied to the audio-visual output device 116 for conveyance to the subscriber 102. In addition, and according to a non-limiting example embodiment of the present invention, the data elements 302A, 302B, 302C are also processed by the processing unit 128. Specifically, the processing unit 128 runs an interactive application, which can be an iTV application. The interactive application may have been previously downloaded over a data channel and installed by the STB 112. Alternatively, the interactive application may be pre-programmed in the STB 112.

The interactive application is operable to perform a first stage of processing, in which the interactive application is on standby for data elements (such as data elements 302A, 302B, 302C) appearing in the specific television content stream 134B. Upon detection of the appearance of a data element in the specific television content stream 134B, the interactive application enters a second stage of processing. This second stage of processing may take on a variety of forms, as will now be described.

For example, the second stage of processing may simply consist of waiting for the subscriber 102 to respond to the advertisement currently appearing on the audio-visual output device 116, and interpreting certain responses as a “selection” of the advertisement. For example, the subscriber's response can be interpreted to be a “selection” when a particular button or sequence of buttons has been pressed on the selection device 118. Alternatively, a special-purpose button on the selection device 118 may be provided for this purpose. If a selection is deemed to have been made, the contact telephone number contained in the data element that is synchronized with the advertisement that appeared on the audio-visual output device 116 when the subscriber's response was received is then stored for eventual transmission to the content provider 104.

In another example, the second stage of processing may trigger the appearance of a window on the audio-visual output device 116. The window, which in a non-limiting embodiment may be a pop-up window, can alert the subscriber 102 to the fact that the advertisement currently appearing on the audio-visual output device 116 is associated with a contact telephone number. In addition, the window may represent a request for feedback by soliciting a response from the subscriber 102, such as by displaying “INTERESTED? PRESS 1 for YES and 2 for NO” or any conceivable variant thereof. The subscriber's response is captured by the processing unit 128 and, if the subscriber has pressed the appropriate button or sequence of buttons on the selection device 118, the subscriber's response may be interpreted as constituting a “selection” of the advertisement currently appearing on the audio-visual output device 116. In this case, the contact telephone number contained in the data element that is synchronized with the advertisement that appeared on the audio-visual output device 116 when the subscriber's response was received is then stored for eventual transmission to the content provider 104.

It should be appreciated that a given advertisement may or may not audio-visually convey a telephone number, which (if conveyed) may or may not correspond to the contact telephone number contained in the data element that is synchronized with the given advertisement. Thus, in cases where it is desired to inform the subscriber of the contact telephone number, it is within the scope of the present invention to juxtapose the contact telephone number with the advertisement. This may be achieved through use of the aforementioned window.

Optionally, once the subscriber 102 is deemed to have made a selection, the interactive application may prompt the subscriber 102 to enter a telephone number where the subscriber 102 wishes to be reached. The subscriber 102 may respond by keying in the desired telephone number using the selection device 118. Alternatively, the desired telephone number may be stored in a memory accessed by the processing unit 128. This feature, which is occasionally referred to herein below as an “override” feature, would allow the subscriber 102 to override the subscriber telephone number contained in the field 230 of the record 200 stored in the database 108 at the content provider 104. In fact, this feature could permit the database 108 to be done away with entirely.

Assume now that the subscriber's response is deemed to be a selection of a particular advertisement, and assume further that the particular advertisement was synchronized with data element 302A which contains the contact telephone number of the source entity 138. This particular contact telephone number will hereinafter be referred to as the “target telephone number”, to convey the notion that it is the result of a selection having been made by the subscriber 102.

The interactive application enters a third stage of processing during which a return message 304A or 304B is sent to the return path module 146 over the return path. Specifically, and with continued reference to FIG. 3A, the return message 304A or 304B comprises a data element 312 containing the target telephone number and a data element 342 containing the STB identifier. In addition, if the override feature described previously is in effect, then the return message 304A or 304B comprises a data element 344 containing a dynamically selected subscriber telephone number.

It should be appreciated that the processing unit 128 may be adapted to send the return message 304A or 304B immediately upon completion of the second processing stage, or only after a delay. The application of a delay may be useful in order to not interrupt the subscriber's viewing of the television show. If used, the delay may be fixed or pre-configurable by the subscriber 102. Alternatively, the subscriber 102 may enter a preferred time at which he or she wishes to have the return message 304A or 304B sent to the content provider 104. Still alternatively, the subscriber 102 may enter a preferred time at which he or she wishes to enter into contact with the source entity 138, and this preferred time will be contained in a data element 346 that is part of the return message 304A or 304B, along with the data elements 312, 342 and 344 containing, respectively, the target telephone number, the STB identifier and, if applicable, the dynamically selected subscriber telephone number 344. It should be appreciated that the preferred time may also represent a time, not before which or not after which the subscriber 102 wishes to enter into contact with the source entity 138.

Still alternatively, the target telephone number may be stored in a memory accessed by the processing unit 128; then, at a later time when it is convenient for the subscriber 102 to do so, the subscriber may interact with the STB 112 (e.g., by way of an iTV application) in order to recall the target telephone number and trigger transmission of the message 304A or 304B to the return path module 146.

Upon receipt of the return message 304A or 304B from the STB 112, the return path module 146 extracts the data element 312 containing the target telephone number and the data element 342 containing the STB identifier, and performs the following process. Firstly, assuming that the return message 304A or 304B does not contain the data element 344 containing the subscriber telephone number, the return path module 146 consults the database 108 based on the STB identifier and accesses the record 200 for the subscriber 102. In particular, the return path module 146 extracts the contents of field 230, thereby obtaining the subscriber telephone number for the subscriber 102. Of course, the previous step may be omitted if the return message 304A or 304B received from the STB 112 contains a data element 344 dynamically selected subscriber telephone number, since the latter will obviate the need for field 230.

For the purposes of the present example, it is assumed that the subscriber telephone number (either extracted from the database 108 or comprised in the data element 312 in the return message 304A or 304B) identifies the telephony device 120. Using both the subscriber telephone number and the target telephone number, the return path module 146 sends a “call initiation message” 306 to the call control module 144. In two non-limiting example embodiments, the call initiation message can be a SOAP message or an XML message.

The call initiation message 306 includes a data element 380 containing an origination party telephone number and a data element 382 containing a destination party telephone number. In an example that may be appropriate for traditional billing arrangements, the origination party telephone number can be the subscriber telephone number and the destination party telephone number can be the target telephone number. Of course, the reverse may be done in an alternative embodiment.

If a preferred time was specified in the data element 346 in the return message 304A or 304B received from the STB 112, then the return path module 146 may strive to send the call initiation message 306 to the call control unit 144 at around the preferred time (or not before the preferred time, or not after the preferred time, depending on operational significance of the “preferred time”). Alternatively, the call initiation message 306 may additionally specify the preferred time.

The call initiation message 306 is interpreted by the call control module 144 as a trigger to initiate a connection between the entities responsive to the origination party telephone number and the destination party telephone number.

In an example embodiment, and with reference to FIG. 3B, the call control module 144 attempts to establish a first telephony leg 350 with the source entity 138. Where the communication device 140 is reachable by a telephone line in the PSTN, the first telephony leg 350 can be established by dialing the target telephone number (e.g., using SS7 commands) and waiting for the communication device 140 to be answered. Alternatively, when the communication device 140 is reachable by an IP address in a data network, the first telephony leg 350 can be established by issuing (or causing a softswitch to issue) a SIP invite to the communication device 140 via the communication network 122 and waiting for the communication device 140 to be answered.

Either contemporaneously with establishment of the first telephony leg 350, or possibly only once the call control module 144 obtains confirmation that the communication device 140 has been answered, the call control module 144 attempts to establish a second telephony leg 360 with the subscriber 102. Where the telephony device 120 is reachable by a telephone line in the PSTN, the second telephony leg 360 can be established by dialing the subscriber telephone number (e.g., using SS7 commands) and waiting for the telephony device 120 to be answered. Alternatively, when the telephony device 120 is reachable by an IP address in a data network, the second telephony leg 360 can be established by issuing (or causing a softswitch to issue) a SIP invite to the telephony device 120 via the communication network 122 and waiting for the telephony device 120 to be answered.

Of course, the reverse scenario is possible. Specifically, the call control module 144 may establish the aforementioned first telephony leg 350 after establishment (or beginning establishment) of the aforementioned second telephony leg 360.

Once both telephony legs 350, 360 have been established, the two legs are bridged in a back-to-back fashion, allowing an end-to-end telephony link to be established between the subscriber 102 and the source entity 138. Those skilled in the art are expected to be familiar with techniques for creating a bridge between the first and second telephony legs 350, 360, and hence further details need not be provided here.

From the above, it will be observed that upon making selections to express his or her interest in a particular advertisement, the subscriber 102 will be placed into telephonic communication with the source entity 138 that is associated with the advertisement. This increases the convenience with which the subscriber 102 can order various products and services, since there is no need to memorize any telephone numbers. In fact, the subscriber 102 might not ever learn the actual contact telephone number of the source entity 138, which may be in a different area code. Thus, what has been achieved is a decoupling of the geographic location of the source entity 138 with respect to the geographic area of the audience for the particular advertisement, thereby affording a cost savings for the advertiser.

In addition, where the television distribution network 106 is an IPTV system, an xDSL system or a cable system, it is envisaged that one single audio-visual advertisement may be associated with multiple different data elements (i.e., contact telephone numbers). For example, although different members of the intended audience for a common advertisement may have a unique geographic or linguistic attribute, this geographic or linguistic attribute can be taken account by designing the data element 302A to be different when sent to different subscribers.

Thus, the data element 302A sent to English-speaking subscribers may contain a first contact telephone number of a department of the source entity 138 where service is provided in English, while the data element 302A sent to Spanish-speaking subscribers may contain a second contact telephone number of a department of the source entity 138 where service is provided in Spanish.

Analogously, the data element 302A sent to subscribers in a geographic region A may contain a first contact telephone number of a first division of the source entity 138, while the data element 302A sent to subscribers in a geographic region B may contain a second contact telephone number of a second division of the source entity 138. The geographic regions may correspond to distinct provinces/states, distinct services areas of respective central offices, etc.

In order to incorporate different subscribers' attribute values where the attribute is a language preference, the transmission module 148 may access a database where language preferences are stored, based on a collection of data that may occur during a registration phase or during viewing. In order to incorporate different subscribers' attribute values where the attribute is a geographic location, the transmission module 148 may access a database where subscriber area codes and/or postal codes are stored, based on a collection of data that may occur during a registration phase.

The above demonstrates an increased flexibility, making the subscriber's experience of viewing advertisements more pleasant, focused and potentially likely to result in a display of interest.

In a variant of the above-described embodiment, the source entity 138 may be a distributed entity and thus reachable by a number of different contact telephone numbers. For example a plurality of contact telephone numbers may be assigned to franchises in different geographic regions to allow rapid delivery of a product such as pizza. In this case, subscribers in a given geographic region (e.g., area code) may need to dial a specific contact telephone number for that area code. However, the advertiser may decide that providing a multiplicity of telephone numbers on a TV screen may be unappealing, as most of the information is irrelevant to most subscribers in any given area code.

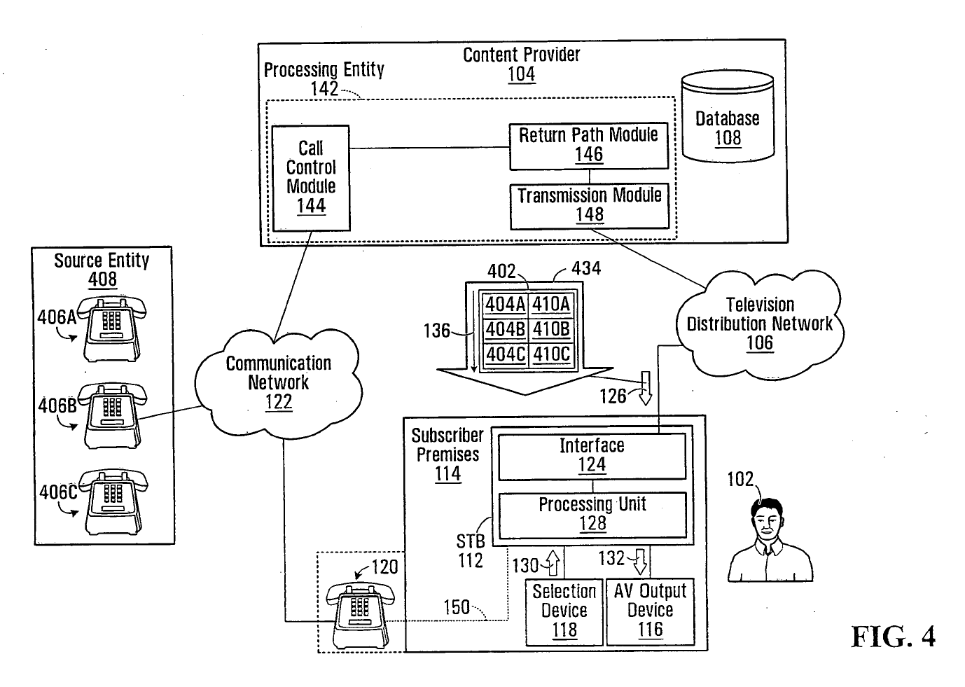

To this end, and with reference to FIG. 4, an embodiment of the present invention contemplates that a data element 402 can appear in a specific television content stream 434. The data element 402 is synchronized with an advertisement appearing in the substream 136, which is also contained in the specific television content stream 434. The data element 402 comprises a plurality of contact telephone numbers 404A, 404B, 404C and optional accompanying attribute values 410A, 410B, 410C. The contact telephone numbers 404A, 404B, 404C specify the telephone numbers where respective sub-entities 406A, 406B, 406C related to a distributed master source entity 408 for an advertised product or service may be reached. The optional accompanying attribute values 410A, 410B, 410C may specify a language or geographic location associated with the corresponding contact telephone number, for example. Other data elements (not shown) may appear in the specific television content stream 434 and other television content streams.

At the STB 112, the specific television content stream 434 (which contains the substream 136 and the data element 402) is processed as follows. Firstly, as has already been described, the processing unit 128 converts the substream 136 of the specific television content stream 434 carrying the television show into the aforementioned audio-visual signal 132, which is supplied to the audio-visual output device 116 for conveyance to the subscriber 102. In addition, and according to a non-limiting example embodiment of the present invention, the data element 402 is also processed by the processing unit 128. Specifically, the processing unit 128 runs an interactive application, which can be an iTV application. The interactive application may have been previously downloaded over a data channel and installed by the STB 112. Alternatively, the interactive application may be pre-programmed in the STB 112.

The interactive application is operable to perform a first stage of processing, in which the interactive application is on standby for data elements (such as the data element 402) appearing in the specific television content stream 434. Upon detection of the appearance of a data element in the specific television content stream 434, the interactive application enters a second stage of processing. This second stage of processing may take on a variety of forms, as will now be described.

For example, the second stage of processing may simply consist of waiting for the subscriber 102 to respond to the advertisement currently appearing on the audio-visual output device 116, and interpreting certain responses as a “selection” of the advertisement. For example, the subscriber's response can be interpreted to be a “selection” when a particular button or sequence of buttons has been pressed on the selection device 118. Alternatively, a special-purpose button on the selection device 118 may be provided for this purpose.

Once a subscriber selection is deemed to have been made, the processing unit 128 selects one of the contact telephone numbers 404A, 404B, 404C contained in the data element 402 that is synchronized with the advertisement that appeared on the audio-visual output device 116 when the subscriber's response was received. Selection of one of the contact telephone numbers 404A, 404B, 404C can be performed in a variety of ways.

In one specific non-limiting embodiment, selection of one of the contact numbers may be made on the basis of attempting to identify which of the contact telephone numbers 404A, 404B, 404C is geographically closest to the customer premises 114. The “location” of the contact telephone numbers 404A, 404B, 404C may be implicit in their area code, or it may be specified by the accompanying attribute value 410A, 410B, 410C. For its part, the “location” of the customer premises 114 may be derived from information stored in the STB 112, such as the area code of the subscriber telephone number, a city name or postal code. Alternatively, the “location” of the customer premises 114 may be derived from GPS coordinates output by a GPS receiver connected to the STB 112.

In another specific non-limiting embodiment, selection of one of the contact numbers may be made on the basis of attempting to identify which of the contact telephone numbers 404A, 404B, 404C provides the best service to the subscriber 102, in accordance with subscriber parameters (e.g., language preference). To this end, the various attribute values 410A, 410B, 410C which accompany the contact telephone numbers 404A, 404B, 404C may specify different languages of service. For its part, the subscriber's “language preference” may be obtained from the subscriber 102 during viewing through interaction with the selection device 118. Alternatively, the subscriber's language preference may be stored in a memory accessed by the processing unit 128. Still alternatively, the subscriber's language preference may be obtained from a data element in the specific television content stream.

In another example, the second stage of processing may consist of the processing unit 128 causing the appearance of a window on the audio-visual output device 116. The window, which in a non-limiting embodiment may be a pop-up window, can alert the subscriber 102 to the fact that the advertisement currently appearing on the audio-visual output device 116 is associated with a contact telephone number (or, in this case, more than one contact telephone number). In addition, the window may represent a request for feedback by soliciting a response from the subscriber 102, such as by displaying “INTERESTED? PRESS 1 for YES and 2 for NO” or any conceivable variant thereof. The subscriber's response is captured by the processing unit 128 and, if the subscriber has pressed the appropriate button or sequence of buttons on the selection device 118, the subscriber's response may be interpreted as constituting a “selection” of the advertisement currently appearing on the audio-visual output device 116.

In the present variant, it is noted that there is a plurality of contact telephone numbers available for the subscriber 102 to choose from. Thus, the window may display the various contact telephone numbers 404A, 404B, 404C contained in the data element 402 that is synchronized with the advertisement that appeared on the audio-visual output device 116 when the subscriber's response was received. The window further permits the subscriber 102 to select one of these, e.g., on the basis of any criterion that the subscriber 102 may deem appropriate. To assist the subscriber 102 in making the selection, the window may display the accompanying attribute values 410A, 410B, 401C in association with each contact telephone number 404A, 404B, 404C. For example, the accompanying attribute value may be a particular city name, language of service, etc.

Once the subscriber 102 is deemed to have made a selection, the selected contact telephone number is stored for eventual transmission to the content provider 104. The selected contact telephone number will hereinafter be referred to as the “target telephone number”. Optionally, once the subscriber 102 is deemed to have made a selection, the interactive application may prompt the subscriber 102 to enter a telephone number where the subscriber 102 wishes to be reached. The subscriber 102 may respond by keying in the desired telephone number using the selection device 118. Alternatively, the desired telephone number may be stored in a memory accessed by the processing unit 128. This feature, which can be referred to as an “override” feature, would allow the subscriber 102 to override the subscriber telephone number contained in the field 230 of the record 200 stored in the database 108 at the content provider 104. In fact, this feature could permit the database 108 to be done away with entirely.

The interactive application now enters a third stage of processing, which is identical to the previously described third stage of processing and hence need not be described in further detail here. Similarly, the actions of the processing entity 142 are identical to those described above, resulting in the establishment of two telephony legs, one between the call control module 144 and the communication device 140 of the source entity 406A, 406B or 406C corresponding to the target telephone number, the other between the call control module 144 and the telephony device 120. Once both telephony legs have been established, the call control module 144 may connect the two legs in a back-to-back fashion as described above.

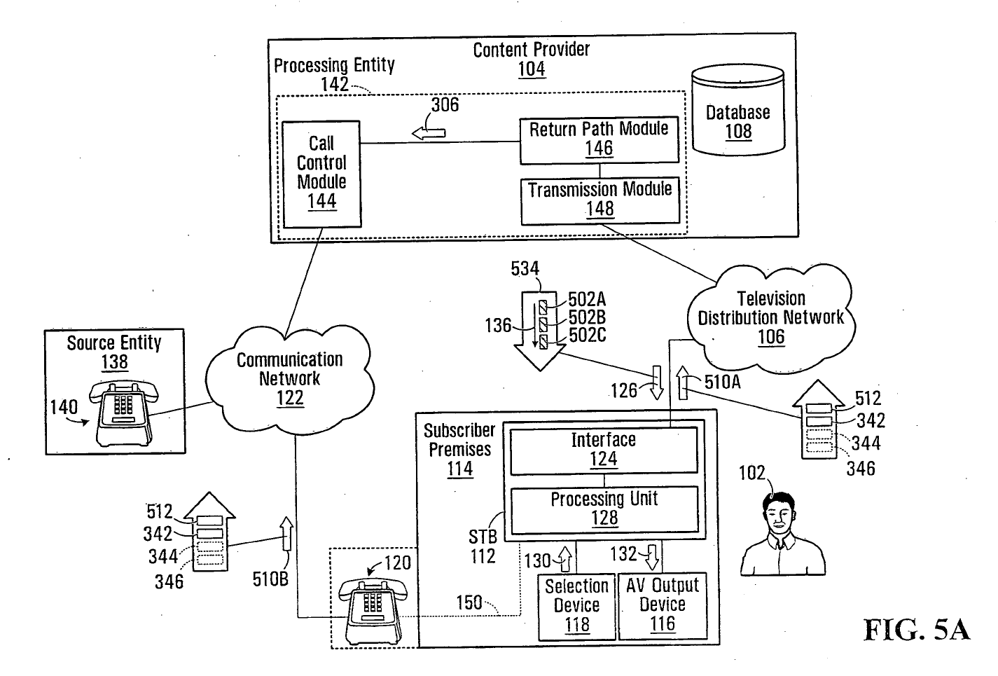

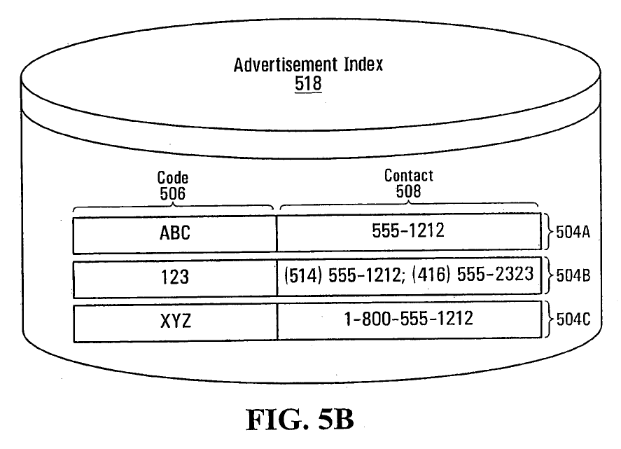

In accordance with a further variant of the present invention, now described with reference to FIGS. 5A and 5B, it is assumed that the specific content stream is a specific television content stream 534 that includes the aforementioned substream 136 carrying a television show. It continues to be the case that the television show includes advertisements associated with so-called “data elements” inserted into the specific television content stream 534, although in this case the data elements are denoted 502A, 502B and 502C. This different notation is due to the fact that in the present variant, the data elements 502A, 502B, 502C comprise respective “advertisement codes” corresponding to the advertisements with which they are synchronized.

To understand how the advertising codes comprised in the data elements 502A, 502B, 502C are processed by the STB 112, it should be explained that the content provider 104 maintains or has access to an additional database 518, referred to as an “advertisement index”, which comprises a plurality of records 504A, 504B, 504C associated with respective advertisements. Each of the records 504A, 504B, 504C comprises a code field 506 which stores the advertisement code for the associated advertisement. In this case, by way of non-limiting example, the code field 506 for the records 504A, 504B, 504C stores the advertisement codes ABC, 123 and XYZ, respectively.

In addition, each of the records 504A, 504B, 504C comprises a contact field 508 which stores one or more respective contact telephone numbers for the associated advertisement. A contact telephone number appearing in the contact field 508 of a record associated with a given advertisement can contain the telephone number(s) at which a source entity for the given advertisement can be reached. For example, in the illustrated embodiment, the contact field 508 of record 504A contains “555-1212”, and let this be the contact telephone number of the source entity 138. Additionally, the contact field 508 of record 504B contains “(514) 555-1212” and “(416) 555-2323”, which are the contact telephone numbers of a pair of source entities (e.g., sub-entities 406A and 406B from FIG. 4). Finally, the contact field 508 of record 504C contains “1-800-555-1212”, which is the contact telephone number of yet another source entity (e.g., sub-entity 406C from FIG. 4).

At the STB 112, the specific television content stream 534 (which contains the substream 136 and the data elements 502A, 502B, 502C) is processed as follows. Firstly, in similar fashion to what has already been described, the processing unit 128 converts the substream 136 of the specific television content stream 534 carrying the television show into the aforementioned audio-visual signal 132, which is supplied to the audio-visual output device 116 for conveyance to the subscriber 102. In addition, and according to a non-limiting example embodiment of the present invention, the data elements 502A, 502B, 502C are also processed by the processing unit 128. Specifically, the processing unit 128 runs an interactive application, which can be an iTV application. The interactive application may have been previously downloaded over a data channel and installed by the STB 112. Alternatively, the interactive application may be pre-programmed in the STB 112.

The interactive application is operable to perform a first stage of processing, in which the interactive application is on standby for data elements (such as data elements 502A, 502B, 502C) appearing in the specific television content stream 534. Upon detection of the appearance of a data element in the specific television content stream 534, the interactive application enters a second stage of processing. This second stage of processing may take on a variety of forms, as will now be described.

For example, the second stage of processing may simply consist of waiting for the subscriber 102 to respond to the advertisement currently appearing on the audio-visual output device 116, and interpreting certain responses as a “selection” of the advertisement. For example, the subscriber's response can be interpreted to be a “selection” when a particular button or sequence of buttons has been pressed on the selection device 118. Alternatively, a special-purpose button on the selection device 118 may be provided for this purpose. If a selection is deemed to have been made, the advertisement code contained in the data element that is synchronized with the advertisement that appeared on the audio-visual output device 116 when the subscriber's response was received is then stored for eventual transmission to the content provider 104.

In another example, the second stage of processing may trigger the appearance of a window on the audio-visual output device 116. The window, which in a non-limiting embodiment may be a pop-up window, can alert the subscriber 102 to the fact that the advertisement currently appearing on the audio-visual output device 116 is associated with a contact telephone number—albeit stored at the advertisement index 518. In addition, the window may represent a request for feedback by soliciting a response from the subscriber 102, such as by displaying “INTERESTED? PRESS 1 for YES and 2 for NO” or any conceivable variant thereof. The subscriber's response is captured by the processing unit 128 and, if the subscriber has pressed the appropriate button or sequence of buttons on the selection device 118, the subscriber's response may be interpreted as constituting a “selection” of the advertisement currently appearing on the audio-visual output device 116. In this case, the advertisement code contained in the data element that is synchronized with the advertisement that appeared on the audio-visual output device 116 when the subscriber's response was received is stored for eventual transmission to the content provider 104.

Optionally, once the subscriber 102 is deemed to have made a selection, the interactive application may prompt the subscriber 102 to enter a telephone number where the subscriber 102 wishes to be reached. The subscriber 102 may respond by keying in the desired telephone number using the selection device 118. Alternatively, the desired telephone number may be stored in a memory accessed by the processing unit 128. This feature, which is occasionally referred to herein below as an “override” feature, would allow the subscriber 102 to override the subscriber telephone number contained in the field 230 of the record 200 stored in the database 108 at the content provider 104. In fact, this feature could permit the database 108 to be done away with entirely.

Assume now that the subscriber's response is deemed to be a selection of a particular advertisement, and assume further that the particular advertisement was synchronized with data element 502A. The advertisement code contained in data element 502A will hereinafter referred to as the “target advertisement code”. Let this advertisement code be “XYZ”.

The interactive application now enters a third stage of processing during which a return message 510A or 510B is sent to the return path module 146 over the return path. Specifically, and with continued reference to FIG. 5A, the return message 510A or 510B comprises a data element 512 containing the target advertisement code (in this case, “XYZ”) and the aforementioned data element 342 containing the STB identifier. In addition, if the override feature described previously is in effect, then the return message 510A or 510B comprises the aforementioned data element 344 containing a dynamically selected subscriber telephone number.

It should be appreciated that the processing unit 128 may be adapted to send the return message 510A or 510B immediately upon completion of the second processing stage, or only after a delay. The application of a delay may be useful in order to not interrupt the subscriber's viewing of the television show. If used, the delay may be fixed or pre-configurable by the subscriber 102. Alternatively, the subscriber 102 may enter a preferred time at which he or she wishes to have the return message 510A or 510B sent to the content provider 104. Still alternatively, the subscriber 102 may enter a preferred time at which he or she wishes to enter into contact with the source entity 138, and this preferred time will be containing in the aforementioned data element 346 that is part of the return message 510A or 510B, along with the data elements 512, 344 and 346 containing, respectively, the target advertisement code, the STB identifier and, if applicable, the dynamically selected subscriber telephone number. It should be appreciated that the preferred time may also represent a time, not before which or not after which the subscriber 102 wishes to enter into contact with the source entity 138.

Still alternatively, the target telephone number may be stored in a memory accessed by the processing unit 128; then, at a later time when it is convenient for the subscriber 102 to do so, the subscriber may interact with the STB 112 (e.g., by way of an iTV application) in order to recall the target telephone number and trigger transmission of the message 510A or 510B to the return path module 146.

Upon receipt of the return message 510A or 510B from the STB 112, the return path module 146 extracts the target advertisement code and the STB identifier, and performs the following process. Firstly, assuming that the return message 510A or 510B does not contain a subscriber telephone number, the return path module 146 consults the database 108 based on the STB identifier and accesses the record 200 for the subscriber 102. In particular, the return path module 146 extracts the contents of field 230, thereby obtaining the subscriber telephone number for the subscriber 102. Of course, the previous step may be omitted if the return message 510A or 510B received from the STB 112 contains a dynamically selected subscriber telephone number, since the latter will obviate the need for field 230.

For the purposes of the present example, it is assumed that the subscriber telephone number (either extracted from the database 108 or comprised in the return message 510A or 510B) identifies the telephony device 120.

In addition, the return path module 146 consults the advertisement index 518 based on the target advertisement code. In the present example, the return path module accesses the record 504C, since the contents of the code field 506 of the record 504C matches the target advertisement code (namely, “XYZ”). Thus, the return path module 146 extracts the contents of associated contact field 508, namely, “1-800-555-1212”, which as mentioned above is the contact telephone number of the sub-entity 406C. This is hereinafter referred to as the “target telephone number”.

Of course, it is possible that the contents of the associated contact field 508 of another record will comprise a plurality of contact telephone numbers. If this is indeed the case (e.g., as is the case with record 504B), then the return path module 146 may perform additional processing to determine which of these contact telephone numbers should be selected as the target telephone number. Selection of the target telephone number from the plurality of contact telephone numbers can be performed in a variety of ways.

In one specific non-limiting embodiment, selection of the target telephone number from the plurality of contact numbers may be made on the basis of attempting to identify which of the plurality of contact telephone numbers is geographically closest to the customer premises 114. The “location” of a given contact telephone number may be implicit in its area code, or it may be specified by an accompanying attribute value (which may include GPS coordinates). For its part, the “location” of the customer premises 114 may be derived by the return path module 146 on the basis of a postal code, area code, etc., which may be obtained from subscriber billing information.

In another specific non-limiting embodiment, selection of the target telephone number from the plurality of contact numbers may be made on the basis of attempting to identify which of the plurality of contact telephone numbers provides the best service to the subscriber 102, in accordance with subscriber parameters (e.g., language preference) that may be conveyed by the subscriber 102 during a registration phase or by the subscriber or STB 112 during viewing.

In yet another specific non-limiting embodiment, selection of the target telephone number from the plurality of contact numbers may be made on the basis of attempting to identify which of the plurality of contact telephone numbers is most suitable for the current content of the television show carried by substream 136. For example, when the television show is in Spanish, then it may be desirable to select the contact telephone number that provides service to the subscriber 102 in Spanish. Similarly, when the television show is a children's program, then it may be desirable to select the contact telephone number that provides specialized service to children.

Using both the subscriber telephone number and the target telephone number, the return path module 146 sends a call initiation message 306 to the call control module 144, as has been previously described. If a preferred time was specified in the return message 510A or 510B received from the STB 112, then the return path module 146 may strive to send the call initiation message 306 to the call control unit 144 at around the preferred time (or not before the preferred time, or not after the preferred time, as appropriate).

As described before, the call initiation message 306 causes the establishment of two telephony legs, one between the call control module 144 and the communication device 140 associated with the target telephone number, the other between the call control module 144 and the telephony device 120. Once both telephony legs have been established, the call control module 144 may connect the two legs in a back-to-back fashion as described above.

It should be appreciated that the aforementioned embodiments apply when the specific television content stream 134B, 434, 534 (including the substream 136 carrying a television show and the various data elements synchronized with advertisements appearing in the television show) is supplied directly from the content provider 104. The aforementioned embodiments also apply equally well when the specific television content stream 134B, 434, 534 is supplied by a personal video recorder (PVR) that replays the specific television content stream 134B, 434, 534 after a certain amount of time following receipt from the content provider 104.

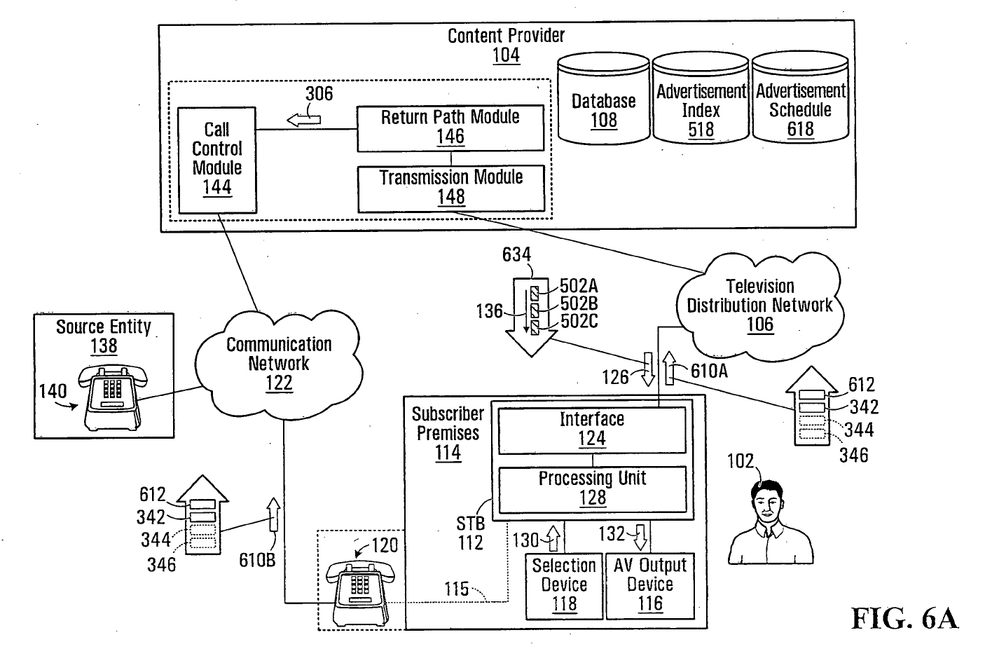

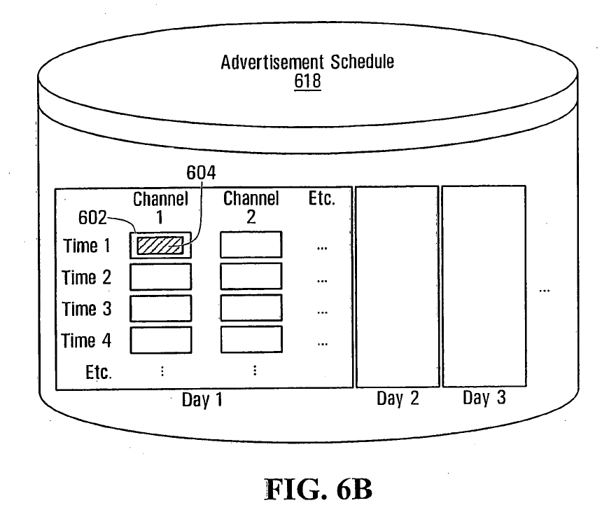

In yet another variant of the present invention, reference is made to FIGS. 6A and 6B. In this embodiment, the specific content stream is a specific television content stream 634 that includes the previously described substream 136 carrying a television show which may include advertisements. However, in this variant, the advertisements appearing in the specific television content stream 634 are not associated with any so-called “data elements”.

Instead, the content provider 104 maintains or has access to an additional database 618, referred to as an advertisement schedule, which stores time slots 602 each of which may or may not contain an advertisement code 604 therein. The time slots can be divided up by date, channel and time interval. In addition, each time slot 602 may be associated with a list of subscribers (e.g., STB identifiers) to whom the advertisement has been sent. In fact, each time slot 602 may be associated with multiple advertisement codes 604, each with its own list of subscribers. In this way, the content provider 104 is able to capture the different advertisement codes that may apply to different subscribers in the same time slot 602.

In addition, the content provider 104 continues to maintain the aforementioned advertisement index 518, made up of records each comprising a code field 506 (which stores the advertisement code for the associated advertisement) and a contact field 508 (which stores one or more respective contact telephone numbers for the associated advertisement). A contact telephone number appearing in the contact field 508 of a record associated with a given advertisement can contain the telephone number(s) at which a source entity for the given advertisement can be reached.

At the STB 112, the specific television content stream 634 (which contains the substream 136) is processed as follows. Quite simply, and similarly to what has already been described, the processing unit 128 converts the substream 136 of the specific television content stream 634 carrying the television show into the aforementioned audio-visual signal 132, which is supplied to the audio-visual output device 116 for conveyance to the subscriber 102.

Meanwhile, and according to a non-limiting example embodiment of the present invention, the processing unit 128 runs an interactive application, which can be an iTV application. The interactive application may have been previously downloaded over a data channel and installed by the STB 112. Alternatively, the interactive application may be pre-programmed in the STB 112.

The interactive application is operable to perform a first stage of processing, in which it waits for the subscriber 102 to provide a selection of an advertisement currently appearing on the audio-visual output device 116. For example, the subscriber's pressing a particular button or sequence of buttons on the selection device 118 can be interpreted by the interactive application to be a “selection”. Alternatively, a special-purpose button on the selection device 118 may be provided for this purpose.

Once a selection is deemed to have been made, the processing unit 128 records the identity of the specific television content stream 634 as well as the time (and optionally the date) at which the subscriber is deemed to have made a selection of an advertisement, hereinafter occasionally referred to as a “time stamp”. If the substream 136 is being played through to the subscriber 102 upon receipt from the content provider 104, then the time stamp may include the current time (and optionally the date) as obtained from an internal clock (not shown) at the STB 112. If the substream 136 is being played back using a personal video recorder (PVR) functionality of the STB 112, then the time stamp may include the time (and optionally the date) as obtained from a time code (not shown) in the substream 136.

The identity of the specific television content stream (hereinafter occasionally referred to as a “channel identifier”), as well as the time stamp, are stored in a subscriber selection packet 612 for eventual transmission to the content provider 104. Those skilled in the art will appreciate that in an IPTV system, the channels that subscribers are watching can be tracked. In such a case, it is redundant for the STB 112 to supply the channel identifier. Rather, the subscriber selection packet 612 sent to the content provider 104 need only contain the time stamp.

Optionally, once the subscriber 102 is deemed to have made a selection of an advertisement, the interactive application may prompt the subscriber 102 to enter a telephone number where the subscriber 102 wishes to be reached. The subscriber 102 may respond by keying in the desired telephone number using the selection device 118. Alternatively, the desired telephone number may be stored in a memory accessed by the processing unit 128. This feature, which is occasionally referred to herein below as an “override” feature, would allow the subscriber 102 to override the subscriber telephone number contained in the field 230 of the record 200 stored in the database 108 at the content provider 104. In fact, this feature could permit the database 108 to be done away with entirely.

The interactive application now enters a second stage of processing during which a return message 610A or 610B is sent to the return path module 146 over the return path. Specifically, and with continued reference to FIG. 6A, the return message 610A or 610B comprises the subscriber selection packet 612 and the aforementioned data element 342 containing the STB identifier. In addition, if the override feature described previously is in effect, then the return message 610A or 610B may also comprise the aforementioned data element 344 containing a dynamically selected subscriber telephone number.

It should be appreciated that the processing unit 128 may be adapted to send the return message 610A or 610B immediately upon completion of the first processing stage, or only after a delay. The application of a delay may be useful in order to not interrupt the subscriber's viewing of the television show. If used, the delay may be fixed or pre-configurable by the subscriber 102. Alternatively, the subscriber 102 may enter a preferred time at which he or she wishes to have the return message 610A or 610B sent to the content provider 104. Still alternatively, the subscriber 102 may enter a preferred time at which he or she wishes to enter into contact with the source entity 138, and this preferred time will be contained in the aforementioned data element 346 that is part of the return message 610A or 610B, along with the subscriber selection packet 612 and the data elements 342 and 344 containing, respectively, the STB identifier and, if applicable, the dynamically selected subscriber telephone number. It should be appreciated that the preferred time may also represent a time, not before which or not after which the subscriber 102 wishes to enter into contact with the source entity 138.

Upon receipt of the return message 610A or 610B from the STB 112, the return path module 146 extracts the subscriber selection packet 612 and the STB identifier, and performs the following process. Firstly, assuming that the return message 610A or 610B does not comprise a subscriber telephone number, the return path module 146 consults the database 108 based on the STB identifier and accesses the record 200 for the subscriber 102. In particular, the return path module 146 extracts the contents of field 230, thereby obtaining the subscriber telephone number for the subscriber 102. Of course, the previous step may be omitted if the return message 610A or 610B received from the STB 112 contains a dynamically selected subscriber telephone number, since the latter will obviate the need for field 230.

In addition, the return path module 146 consults the advertisement schedule 618. Specifically, the return path module 146 finds a time slot 602 in the advertisement schedule 618 which (i) is associated with the channel identifier (if such is contained in the subscriber selection packet 612), and (ii) covers the time period surrounding the time stamp contained in the subscriber selection packet 612. The return path module 146 then extracts the advertisement code 604 (if any) present in the appropriate time slot 602. The extracted advertisement code, should one exist, is hereinafter referred to as the “target advertisement code”.

If there are multiple advertisement codes 604 in the same time slot which are associated with different lists of subscribers, then the STB identifier may be used to further isolate the target advertisement code, if applicable.

In addition, the return path module 146 consults the advertisement index 518 based on the target advertisement code. Assume that the return path module accesses the record 504A, based on a match between the contents of the code field 506 of the record 504A and the target advertisement code. Thus, the return path module 146 extracts the contents of associated contact field 508, which comprises the contact telephone number of the source entity 138, namely, “555-1212”. This hereinafter referred to as the “target telephone number”.

Where the contents of the associated contact field 508 comprises a plurality of contact telephone numbers, the solution described above with reference to FIGS. 5A and 5B could be adopted. Specifically, the return path module 146 may perform additional processing to determine which of these contact telephone numbers should be selected as the target telephone number. Selection of the target telephone number from the plurality of contact telephone numbers can be performed in a variety of ways.

In one specific non-limiting embodiment, selection of the target telephone number from the plurality of contact numbers may be made on the basis of attempting to identify which of the plurality of contact telephone numbers is geographically closest to the customer premises 114. The “location” of a given contact telephone number may be implicit in its area code, or it may be specified by an accompanying attribute value (which may include GPS coordinates). For its part, the “location” of the customer premises 114 may be derived by the return path module 146 on the basis of a postal code, area code, etc., which may be obtained from subscriber billing information.

In another specific non-limiting embodiment, selection of the target telephone number from the plurality of contact numbers may be made on the basis of attempting to identify which of the plurality of contact telephone numbers provides the best service to the subscriber 102, in accordance with subscriber parameters (e.g., language preference) that may be conveyed by the subscriber during a registration phase or during viewing.

In yet another specific non-limiting embodiment, selection of the target telephone number from the plurality of contact numbers may be made on the basis of attempting to identify which of the plurality of contact telephone numbers is most suitable for the current content of the television show carried by substream 136. For example, when the television show is in Spanish, then it may be desirable to select the contact telephone number that provides service to the subscriber 102 in Spanish. Similarly, when the television show is a children's program, then it may be desirable to select the contact telephone number that provides specialized service to children.

It should also be appreciated that instead of containing advertisement codes 604, the time slots 602 may themselves contain the contact telephone numbers, thus obviating the need for an additional indirection step provided by the advertisement index 518.

At this stage, the return path module 146 will have knowledge of the subscriber telephone number (either extracted from the database 108 or comprised in the return message 610A or 610B) as well as the target telephone number. Accordingly, as described previously, the return path module 146 sends the call initiation message 306 to the call control module 144, which causes the establishment of two telephony legs, one between the call control module 144 and the communication device 140, the other between the call control module 144 and the telephony device 120. Once both telephony legs have been established, the call control module 144 may connect the two legs in a back-to-back fashion as described above.

In accordance with a further variant of the present invention, it is assumed that the specific content stream is a specific television content stream that includes the aforementioned substream 136 carrying a television show. It continues to be the case that the television show includes advertisements associated with so-called “data elements” inserted into the specific television content stream. In the present variant, each of the advertisements is synchronized with a respective data elements, regardless of whether to not it is possible to reach a source entity for a particular advertised product or service.

Specifically, certain advertisements are associated with a participating source entity that can be reached by dialing a telephone number. For such advertisements, the corresponding data element can be a flag having a first value. Other advertisements are not associated with a participating source entity, and for those advertisements, the corresponding data element can be a flag having a second value.

At the STB 112, the specific television content stream (which contains the substream 136 and the data elements) is processed as follows. Firstly, in similar fashion to what has already been described, the processing unit 128 converts the substream 136 of the specific television content stream carrying the television show into the aforementioned audio-visual signal 132, which is supplied to the audio-visual output device 116 for conveyance to the subscriber 102. In addition, and according to a non-limiting example embodiment of the present invention, the data elements are also processed by the processing unit 128. Specifically, the processing unit 128 runs an interactive application, which can be an iTV application. The interactive application may have been previously downloaded over a data channel and installed by the STB 112. Alternatively, the interactive application may be pre-programmed in the STB 112.

The interactive application is operable to perform a first stage of processing, in which the interactive application is on standby for data elements appearing in the specific television content stream. Upon detection of the appearance of a data element in the specific television content stream, the interactive application enters a second stage of processing.

In a first non-limiting variant of the second stage of processing, the second stage of processing may simply consist of waiting for the subscriber 102 to respond to the advertisement currently appearing on the audio-visual output device 116, and interpreting certain responses as a “selection” of the advertisement. For example, the subscriber's response can be interpreted to be a “selection” when a particular button or sequence of buttons has been pressed on the selection device 118. Alternatively, a special-purpose button on the selection device 118 may be provided for this purpose.

If a selection is deemed to have been made during a specific advertisement, but the data element that is synchronized with that specific advertisement is a flag having the second value, then the second stage of processing triggers the appearance of a denial-type window on the audio-visual output device 116. The denial-type window, which in a non-limiting embodiment may be a pop-up window, can alert the subscriber 102 to the fact that the advertisement currently appearing on the audio-visual output device 116 is not associated with a contact telephone number, i.e., conveying the fact that the subscriber's selection is in vain.

If, however, the selection is deemed to have been made during a specific advertisement synchronized with a data element that is a flag having the first value, then the second stage of processing triggers the appearance of an acceptance-type window on the audio-visual output device 116. The acceptance-type window, which in a non-limiting embodiment may be a pop-up window, can alert the subscriber 102 to the fact that the advertisement currently appearing on the audio-visual output device 116 is associated with a contact telephone number. The processing unit 128 records the identity of the specific television content stream as well as the time (and optionally the date) at which the subscriber is deemed to have made the advertisement, hereinafter occasionally referred to as a “time stamp”. The remainder of the process is as described above.

In a second non-limiting variant of the second stage of processing, the second stage of processing may consist of causing the appearance of the appropriate message (e.g., denial-type or acceptance-type pop-up window) each time that an advertisement appears in the specific television content stream. When the message takes the form of an acceptance-type pop-up window, the subscriber 102 is alerted to the fact that the advertisement currently appearing on the audio-visual output device 116 is associated with a contact telephone number. The second stage of processing then continues by waiting for the subscriber 102 to respond to the advertisement, and interpreting certain responses as a “selection” of the advertisement. If a selection is deemed to be made, the processing unit 128 records the identity of the specific television content stream as well as the time (and optionally the date) at which the subscriber is deemed to have made the selection, hereinafter occasionally referred to as a “time stamp”. The remainder of the process is as described above.

Those skilled in the art will appreciate, in particular, that the present invention is not limited to eliciting and conveying from a subscriber an indication of a selection of a particular advertisement for a product or service. Rather, the present invention is also applicable to eliciting and conveying from a subscriber an indication of a selection of an information element that is deemed to be of potential interest to a multi-subscriber audience that includes the subscriber, non-limiting examples of which include:
a television show/movie, containing embedded product or service placements (“plugs”) at strategic moments;
a television show, when aimed specifically at shoppers (e.g., a home shopping channel, whose raison d'être is to provide viewers with continuous opportunities to purchase a product or service);
a solicitation for a charitable contribution;
a public service announcement, inviting viewers to speak to someone at the other end of a kids help line, suicide prevention hotline, domestic violence sanctuary hotline, crime stoppers hotline, etc.;
an announcement made by a fan club, inviting viewers to speak to a representative of the fan club;
a survey, poll or vote, where a viewer is asked to indicate a preference (such as a singer, musician, etc.) by dialing a specific telephone associated with his or her preference;
a survey, poll or vote, requiring confirmation of viewer input via a telephone;
an announcement for a call-in talk show or debate, inviting viewers to speak to the show's host or participate in the debate;
etc.

While specific embodiments of the present invention have been described and illustrated, it will be apparent to those skilled in the art that numerous modifications and variations can be made without departing from the scope of the invention as defined in the appended claims.

1. A method, comprising:
releasing to at least one television service subscriber a content stream conveying at least one information element deemed to be of potential interest to a multi-subscriber audience that includes the at least one television service subscriber;
receiving from a particular one of the at least one television service subscriber an indication of a selection of a particular one of the at least one information element;
determining a telephone number associated with the particular television service subscriber;
determining a telephone number associated with the particular information element;
establishing a first telephony leg on a basis of the telephone number associated with the particular information element;
establishing a second telephony leg on a basis of the telephone number associated with the particular television service subscriber;
joining the first and second telephony legs to form an end-to-end telephony link for the particular television service subscriber.

2. The method defined in claim 1, wherein the content stream further conveys an identifier associated with the particular information element.

3. The method defined in claim 2, wherein appearance of the identifier associated with the particular information element within the content stream is synchronized with appearance of the particular information element within the content stream.

4. The method defined in claim 2, wherein said receiving an indication of a selection of a particular one of the at least one information element comprises receiving the identifier associated with the particular information element.

5. The method defined in claim 4, wherein the identifier associated with the particular information element comprises the telephone number associated with the particular information element.

6. The method defined in claim 5, wherein said determining a telephone number associated with the particular information element comprises extracting the telephone number associated with the particular information element from the identifier associated with the particular information element.

7. The method defined in claim 4, wherein said determining a telephone number associated with the particular information element comprises querying a database with the identifier associated with the particular information element to obtain a telephone number therefrom, the database storing a plurality of records, each record maintaining an association between (i) a respective identifier associated with a respective information element and (ii) a respective telephone number.

8. The method defined in claim 4, wherein said determining a telephone number associated with the particular information element comprises querying a database with
the identifier associated with the particular information element; and
an attribute value associated with the particular television subscriber;
to obtain a telephone number therefrom, the database storing a plurality of records, each record maintaining an association between (i) a respective identifier associated with a respective information element and (ii) at least one respective telephone number corresponding to a respective attribute value.

9. The method defined in claim 8, wherein said determining a telephone number associated with the particular information element further comprises determining the attribute value associated with the particular television subscriber.

10. The method defined in claim 9, wherein determining the attribute value associated with the particular television subscriber comprises querying a second database with an identity of the particular television service subscriber to obtain an attribute value therefrom, the second database storing a plurality of records, each record maintaining an association between (i) a respective identity of a television service subscriber and (ii) a respective attribute value.

11. The method defined in claim 10, wherein the attribute is a language preference.

12. The method defined in claim 10, wherein the attribute is a geographic location.

13. The method defined in claim 10, further comprising determining the identity of the particular television subscriber.

14. The method defined in claim 13, wherein determining the identity of the particular television subscriber comprises receiving from the particular television service subscriber an identifier of a set-top box being used by the particular television service subscriber.

15. The method defined in claim 9, further comprising receiving from the particular television service subscriber a data element containing the attribute value associated with the particular television subscriber.

16. The method defined in claim 15, wherein determining the attribute value associated with the particular television subscriber comprises extracting the attribute value associated with the particular television subscriber from the data element.

17. The method defined in claim 16, wherein the attribute is a language preference.

18. The method defined in claim 16, wherein the attribute is a geographic location.

19. The method defined in claim 1, wherein the content stream further conveys a plurality of identifiers associated with the particular information element.

20. The method defined in claim 19, wherein appearance of the identifiers associated with the particular information element within the content stream is synchronized with appearance of the particular information element within the content stream.

21. The method defined in claim 19, wherein said receiving an indication of a selection of a particular one of the at least one information element comprises receiving a selected one of the identifiers associated with the particular information element.

22. The method defined in claim 21, wherein the selected one of the identifiers associated with the particular information element comprises the telephone number associated with the particular information element.

23. The method defined in claim 22, wherein said determining a telephone number associated with the particular information element comprises extracting the telephone number associated with the particular information element from the selected one of the identifiers associated with the particular information element.

24. The method defined in claim 21, wherein said determining a telephone number associated with the particular information element comprises querying a database with the selected one of the identifiers associated with the particular information element to obtain a telephone number therefrom, the database storing a plurality of records, each record maintaining an association between (i) a respective identifier associated with a respective information element and (ii) a respective telephone number.

25. The method defined in claim 21, wherein said determining a telephone number associated with the particular information element comprises querying a database with
the selected one of the identifiers associated with the particular information element; and
an attribute value associated with the particular television subscriber;
to obtain a telephone number therefrom, the database storing a plurality of records, each record maintaining an association between (i) a respective identifier associated with a respective information element and (ii) at least one respective telephone number corresponding to a respective attribute value.

26. The method defined in claim 25, wherein said determining a telephone number associated with the particular information element further comprises determining the attribute value associated with the particular television subscriber.

27. The method defined in claim 26, wherein determining the attribute value associated with the particular television subscriber comprises querying a second database with an identity of the particular television service subscriber to obtain an attribute value therefrom, the second database storing a plurality of records, each record maintaining an association between (i) a respective identity of a television service subscriber and (ii) a respective attribute value.

28. The method defined in claim 27, wherein the attribute is a language preference.

29. The method defined in claim 27, wherein the attribute is a geographic location.

30. The method defined in claim 27, further comprising determining the identity of the particular television subscriber.

31. The method defined in claim 30, wherein determining the identity of the particular television subscriber comprises receiving from the particular television service subscriber an identifier of a set-top box being used by the particular television service subscriber.

32. The method defined in claim 25, further comprising receiving from the particular television service subscriber a data element containing the attribute value associated with the particular television subscriber.

33. The method defined in claim 32, wherein determining the attribute value associated with the particular television subscriber comprises extracting the attribute value associated with the particular television subscriber from the data element.

34. The method defined in claim 33, wherein the attribute is a language preference.

35. The method defined in claim 33, wherein the attribute is a geographic location.

36. The method defined in claim 1, wherein said receiving an indication of a selection of a particular one of the at least one information element comprises receiving a time stamp indicative of at least a time at which a selection of the particular information element was made by the particular television service subscriber.

37. The method defined in claim 36, further comprising querying a database with:
the time stamp; and
an identifier of a channel;
to obtain an identifier therefrom, the database storing a plurality of time slots for respective ones of a plurality of channels, each time slot for a given one of the channels covering a respective time interval and corresponding to a respective identifier for that time interval and the given one of the channels.

38. The method defined in claim 37, wherein the identifier obtained from the database comprises the telephone number associated with the particular information element.

39. The method defined in claim 38, wherein said determining a telephone number associated with the particular information element comprises extracting the telephone number associated with the particular information element from the identifier obtained from the database.

40. The method defined in claim 39, wherein said receiving an indication of a selection of a particular one of the at least one information element further comprises receiving the identifier of a channel, the identifier of a channel being indicative of the content stream conveying the particular information element.

41. The method defined in claim 39, further comprising tracking the delivery of content streams to the particular television service subscriber and determining from the time stamp the identity of the content stream conveying the particular information element.

42. The method defined in claim 37, wherein said database is a first database, wherein said determining a telephone number associated with the particular information element comprises querying a second database with the identifier obtained from the first database to obtain a telephone number therefrom, the database storing a plurality of records, each record maintaining an association between (i) a respective identifier and (ii) a respective telephone number.

43. The method defined in claim 37, wherein said database is a first database, wherein said determining a telephone number associated with the particular information element comprises querying a second database with:
the identifier obtained from the first database; and
an attribute value associated with the particular television subscriber;
to obtain a telephone number therefrom, the database storing a plurality of records, each record maintaining an association between (i) a respective identifier and (ii) at least one respective telephone number corresponding to a respective attribute value.

44. The method defined in claim 43, wherein said determining a telephone number associated with the particular information element further comprises determining the attribute value associated with the particular television subscriber.

45. The method defined in claim 44, wherein determining the attribute value associated with the particular television subscriber comprises querying a third database with an identity of the particular television service subscriber to obtain an attribute value therefrom, the third database storing a plurality of records, each record maintaining an association between (i) a respective identity of a television service subscriber and (ii) a respective attribute value.

46. The method defined in claim 45, wherein the attribute is a language preference.

47. The method defined in claim 45, wherein the attribute is a geographic location.

48. The method defined in claim 45, further comprising determining the identity of the particular television subscriber.

49. The method defined in claim 48, wherein determining the identity of the particular television subscriber comprises receiving from the particular television service subscriber an identifier of a set-top box being used by the particular television service subscriber.

50. The method defined in claim 44, further comprising receiving from the particular television service subscriber a data element containing the attribute value associated with the particular television subscriber.

51. The method defined in claim 50, wherein determining the attribute value associated with the particular television subscriber comprises extracting the attribute value associated with the particular television subscriber from the data element.

52. The method defined in claim 51, wherein the attribute is a language preference.

53. The method defined in claim 51, wherein the attribute is a geographic location.

54. The method defined in claim 1, further comprising:
receiving from the particular television service subscriber an identifier of a set-top box being used by the particular television service subscriber.

55. The method defined in claim 54, wherein said determining a telephone number associated with the particular television service subscriber comprises querying a database with the identifier of the set-top box to obtain a telephone number therefrom, the database storing a plurality of records, each record maintaining an association between (i) a respective identifier of a set-top box and (ii) a respective telephone number.

56. The method defined in claim 1, further comprising:
receiving from the particular television service subscriber a data element containing the telephone number associated with the particular television service subscriber.

57. The method defined in claim 56, wherein said determining a telephone number associated with the particular television service subscriber comprises extracting the telephone number associated with the particular television service subscriber from the data element.

58. The method defined in claim A, further comprising:
receiving from the particular television service subscriber an identifier of a set-top box being used by the particular television service subscriber.

59. The method defined in claim previous, wherein said determining a telephone number associated with the particular television service subscriber comprises querying a database with the identifier of the set-top box to obtain a telephone number therefrom, the database storing a plurality of records, each record maintaining an association between (i) a respective identifier of a set-top box and (ii) a respective telephone number.

60. The method defined in claim 4, further comprising:
receiving from the particular television service subscriber a data element containing the telephone number associated with the particular television service subscriber.

61. The method defined in claim 60, wherein said determining a telephone number associated with the particular television service subscriber comprises extracting the telephone number associated with the particular television service subscriber from the data element.

62. The method defined in claim 21, further comprising:
receiving from the particular television service subscriber an identifier of a set-top box being used by the particular television service subscriber.

63. The method defined in claim 62, wherein said determining a telephone number associated with the particular television service subscriber comprises querying a database with the identifier of the set-top box to obtain a telephone number therefrom, the database storing a plurality of records, each record maintaining an association between (i) a respective identifier of a set-top box and (ii) a respective telephone number.

64. The method defined in claim 21, further comprising:
receiving from the particular television service subscriber a data element containing the telephone number associated with the particular television service subscriber.

65. The method defined in claim 64, wherein said determining a telephone number associated with the particular television service subscriber comprises extracting the telephone number associated with the particular television service subscriber from the data element.

66. The method defined in claim 37, further comprising:
receiving from the particular television service subscriber an identifier of a set-top box being used by the particular television service subscriber.

67. The method defined in claim 66, wherein said determining a telephone number associated with the particular television service subscriber comprises querying a database with the identifier of the set-top box to obtain a telephone number therefrom, the database storing a plurality of records, each record maintaining an association between (i) a respective identifier of a set-top box and (ii) a respective telephone number.

68. The method defined in claim 37, further comprising:
receiving from the particular television service subscriber a data element containing the telephone number associated with the particular television service subscriber.

69. The method defined in claim 68, wherein said determining a telephone number associated with the particular television service subscriber comprises extracting the telephone number associated with the particular television service subscriber from the data element.

70. The method defined in claim 1, wherein said establishing a second telephony leg occurs after said first telephony leg has been established.

71. The method defined in claim 1, wherein said establishing a first telephony leg occurs after said second telephony leg has been established.

72. The method defined in claim 1, wherein said establishing a first telephony leg and said establishing a second telephony leg occurs contemporaneously.

73. The method defined in claim 1, wherein said establishing a first telephony leg comprises dialing the telephone number associated with the particular information element over the PSTN.

74. The method defined in claim 1, wherein said establishing a first telephony leg comprises sending a SIP invite to the telephone number associated with the particular information element over a data network.

75. The method defined in claim 1, wherein said establishing a second telephony leg comprises dialing the telephone number associated with the particular television service subscriber over the PSTN.

76. The method defined in claim 1, wherein said establishing a second telephony leg comprises sending a SIP invite to the telephone number associated with the particular television service subscriber over a data network.

77. The method defined in claim 1, wherein said joining the first and second telephony legs comprises establishing a bridge between the first and second telephony legs.

78. X The method defined in claim 1, further comprising receiving from the particular television service subscriber an indication of a preferred time.

79. The method defined in claim 78, further comprising triggering at least one of said establishing a first telephony leg and said establishing a second telephony leg at said preferred time.

80. The method defined in claim 78, further comprising triggering at least one of said establishing a first telephony leg and said establishing a second telephony leg no earlier than said preferred time.

81. The method defined in claim 78, further comprising triggering at least one of said establishing a first telephony leg and said establishing a second telephony leg no later than said preferred time.

82. The method defined in claim 1, wherein said releasing is effected over a satellite TV distribution system.

83. The method defined in claim 1, wherein said releasing is effected over a cable TV distribution system.

84. The method defined in claim 1, wherein said releasing is effected over an xDSL TV distribution system.

85. The method defined in claim 1, wherein said releasing is effected over an IPTV distribution system.

86. The method defined in claim 1, wherein the information element comprises at least one of a commercial advertisement for a product or service; a product or service placement embedded in one of a television show and a motion picture; a solicitation for a charitable contribution; a public service announcement; an announcement made by a fan club; a survey; a poll; a vote; and an announcement for one of a call-in talk show and a debate.

87. The method defined in claim 1, further comprising releasing to the particular television service subscriber a data stream comprising an interactive TV application for installation on a set-top box being used by the particular television service subscriber; when installed, the interactive TV application enabling the set-top box to cause transmission of said indication of a selection of a particular one of the at least one information element.

88. The method defined in claim 87, the interactive TV application further enabling the set-top box to capture said selection of a particular one of the at least one information element.

89. A system, comprising:
a transmission module operable for releasing to at least one television service subscriber a content stream conveying at least one information element deemed to be of potential interest to a multi-subscriber audience that includes the at least one television service subscriber;
a return path module operable for:
receiving from a particular one of the at least one television service subscriber an indication of a selection of a particular one of the at least one information element;
determining a telephone number associated with the particular television service subscriber; and
determining a telephone number associated with the particular information element;
a call control module operable for:
establishing a first telephony leg on a basis of the telephone number associated with the particular information element;
establishing a second telephony leg on a basis of the telephone number associated with the particular television service subscriber; and
joining the first and second telephony legs to form an end-to-end telephony link for the particular television service subscriber.

91. A computer-readable medium comprising computer-readable program code which, when interpreted by a computing apparatus, causes the computing apparatus to execute a method, the computer-readable program code comprising:
first computer-readable program code for causing the computing apparatus to release to at least one television service subscriber a content stream conveying at least one information element deemed to be of potential interest to a multi-subscriber audience that includes the at least one television service subscriber;
second computer-readable program code for causing the computing apparatus to await receipt from a particular one of the at least one television service subscriber of an indication of a selection of a particular one of the at least one information element;
third computer-readable program code for causing the computing apparatus to determine a telephone number associated with the particular television service subscriber;
fourth computer-readable program code for causing the computing apparatus to determine a telephone number associated with the particular information element;
fifth computer-readable program code for causing the computing apparatus to establish a first telephony leg on a basis of the telephone number associated with the particular information element;
sixth computer-readable program code for causing the computing apparatus to establish a second telephony leg on a basis of the telephone number associated with the particular television service subscriber;
seventh computer-readable program code for causing the computing apparatus to join the first and second telephony legs to form an end-to-end telephony link for the particular television service subscriber.

90. A set-top box registered to a television service subscriber, the set-top box comprising:
a first interface adapted to receive from a content provider a content stream conveying at least one information element deemed to be of potential interest to a multi-subscriber audience that includes the television service subscriber;
a second interface adapted to receive a selection by the television service subscriber of a particular one of the at least one information element;
a processing unit operable for effecting a transmission to the content provider of an indication of said selection, said transmission being instrumental in causing a telephone call to be placed to a telephony device;
wherein when the telephone call is answered by a user of the telephony device, the user is placed in communication with an information source associated with the particular information element.

91. The set-top box defined in claim 90, the content stream comprising an audio-visual substream, the processing unit being further operable for extracting the audio-visual substream from the content stream and providing the audio-visual substream to a display device for display to the television service subscriber.

92. The set-top box defined in claim 91, the at least one information element being part of the audio-visual substream.

93. The set-top box defined in claim 92, the content stream further conveying an identifier associated with the particular information element.

94. The set-top box defined in claim 93, wherein said indication of said selection comprises the identifier associated with the particular information element.

95. The set-top box defined in claim 94, wherein the identifier associated with the particular information element is a telephone number of the information source associated with the particular information element.

96. The set-top box defined in claim 94, wherein the identifier associated with the particular information element is other than a telephone number of the information source associated with the particular information element.

97. The set-top box defined in claim 94, the processing unit being further operable for detecting the identifier associated with the particular information element and maintaining the identifier in a memory location during display of the particular information element by the display device.

98. The set-top box defined in claim 97, the processing unit being further operable for being attentive to receipt of subscriber input via the second interface.

99. The set-top box defined in claim 98, the processing unit being further operable to deem receipt of certain subscriber input during display of the particular information element by the display device as constituting selection of the particular information element.

100. The set-top box defined in claim 94, the processing unit being further operable for detecting the identifier associated with the particular information element and causing the display device to display a request for feedback from the television service subscriber regarding the particular information element.

101. The set-top box defined in claim 100, the processing unit being further operable for being attentive to receipt of subscriber input via the second interface.

102. The set-top box defined in claim 101, the processing unit being further operable to deem receipt of certain subscriber input during display of the request for feedback as constituting selection of the particular information element.

103. The set-top box defined in claim 102, the processing unit being further operable to deem receipt of certain other subscriber input during display of the request for feedback as not constituting selection of the particular information element.

104. The set-top box defined in claim 100, wherein the request for feedback is implemented as a pop-up window.

105. The set-top box defined in claim 94, the processing unit being further operable for causing the display device to display a request for a telephone number at which the telephony device can be reached.

106. The set-top box defined in claim 105, the processing unit being further operable for effecting a transmission to the content provider of the telephone number, the telephone number being subsequently used to place said telephone call to the telephony device.

107. The set-top box defined in claim 94, further comprising a memory that stores a telephone number at which the telephony device can be reached, the processing unit being further operable to obtain from said memory the telephone number at which the telephony device can be reached.

108. The set-top box defined in claim 107, the processing unit being further operable for effecting a transmission to the content provider of the telephone number, the telephone number being subsequently used to place said telephone call to the telephony device.

109. The set-top box defined in claim 92, the content stream further conveying a plurality of identifiers associated with the particular information element.

110. The set-top box defined in claim 109, wherein said indication of said selection comprises a selected one of the plurality of identifiers associated with the particular information element.

111. The set-top box defined in claim 110, wherein said selected one of the plurality of identifiers associated with the particular information element is a telephone number of the information source associated with the particular information element.

112. The set-top box defined in claim 110, further comprising a memory, the processing unit being further operable for detecting the plurality of identifiers associated with the particular information element and maintaining the plurality of identifiers in a location in said memory during display of the particular information element by the display device.

113. The set-top box defined in claim 112, the processing unit being further operable for being attentive to receipt of subscriber input via the second interface.

114. The set-top box defined in claim 113, the processing unit being further operable to deem receipt of certain subscriber input during display of the particular information element by the display device as constituting selection of the particular information element.

115. The set-top box defined in claim 114, the processing unit being further operable for effecting a selection of said selected one of the plurality of identifiers associated with the particular information element in response to selection of the particular information element.

116. The set-top box defined in claim 115, wherein each of the plurality of identifiers associated with the particular information element is associated with a respective attribute value, wherein said memory stores a value of an attribute for said television service subscriber, wherein said selection of said selected one of the plurality of identifiers associated with the particular information element is effected on a basis of the value of the attribute for said television service subscriber.

117. The set-top box defined in claim 116, wherein the attribute is a language preference.

118. The set-top box defined in claim 116, wherein the attribute is a geographic location.

119. The set-top box defined in claim 110, the processing unit being further operable for detecting the plurality of identifiers associated with the particular information element and causing the display device to display a request for feedback from the television service subscriber regarding the particular information element.

120. The set-top box defined in claim 119, the processing unit being further operable for being attentive to receipt of subscriber input via the second interface.

121. The set-top box defined in claim 120, the processing unit being further operable to deem receipt of certain subscriber input during display of the request for feedback as constituting selection of the particular information element.

122. The set-top box defined in claim 121, wherein said request for feedback comprises a request for a selection of said selected one of the plurality of identifiers associated with the particular information element.

123. The set-top box defined in claim 121, wherein each of the plurality of identifiers associated with the particular information element is associated with a respective attribute value, wherein said request for feedback comprises a request for a selection of an attribute value for said television service subscriber.

124. The set-top box defined in claim 123, the processing unit being further operable for effecting a selection of said selected one of the plurality of identifiers associated with the particular information element in response to said selection of an attribute value for said television service subscriber.

125. The set-top box defined in claim 110, the processing unit being further operable for causing the display device to display a request for a telephone number at which the telephony device can be reached.

126. The set-top box defined in claim 125, the processing unit being further operable for effecting a transmission to the content provider of the telephone number, the telephone number being subsequently used to place said telephone call to the telephony device.

127. The set-top box defined in claim 110, further comprising a memory that stores a telephone number at which the telephony device can be reached, the processing unit being further operable to obtain from said memory the telephone number at which the telephony device can be reached.

128. The set-top box defined in claim 127, the processing unit being further operable for effecting a transmission to the content provider of the telephone number, the telephone number being subsequently used to place said telephone call to the telephony device.

129. The set-top box defined in claim 92, wherein said indication of said selection comprises a time stamp indicative of at least time at which a selection of the particular information element was made by the television service subscriber.

130. The set-top box defined in claim 129, wherein said time stamp is further indicative of the date on which a selection of the particular information element was made by the television service subscriber.

131. The set-top box defined in claim 130, wherein said indication of said selection comprises a channel indicator indicative of the content stream.

132. The set-top box defined in claim 90, the set-top box having an identifier, the processing unit being further operable for effecting a transmission to the content provider of the identifier of the set-top box.

133. The set-top box defined in claim 90, the second interface being further operable for receiving from the television service subscriber an indication of a preferred time associated with placement of the telephone call to the telephony device.

134. The set-top box defined in claim 133, the processing unit being further operable for effecting said transmission to the content provider at the preferred time.

135. The set-top box defined in claim 133, the processing unit being further operable for effecting a transmission of the preferred time to the content provider.

136. The set-top box defined in claim 90, further comprising a memory storing said indication of said selection, said processing unit being operable for effecting said transmission to the content provider upon receipt of a trigger from the television service subscriber.

137. The set-top box defined in claim 90, the first interface being further adapted to receive from the content provider an interactive TV application for installation on a set-top box being used by the particular television service subscriber; when installed, the interactive TV application enabling the processing unit effect said transmission to the content provider.

138. The set-top box defined in claim 90, wherein said effecting a transmission to the content provider is performed via the first interface.

139. The set-top box defined in claim 138, wherein said first interface comprises an xDSL link.

140. The set-top box defined in claim 139, wherein said first interface comprises a cable link.

141. The set-top box defined in claim 140, wherein said first interface comprises an IPTV link.

142. The set-top box defined in claim 90, wherein the set-top box comprises a third interface to a telephony network, wherein said effecting a transmission to the content provider is performed via the third interface.

143. The set-top box defined in claim 142, wherein said first interface comprises a satellite link.

144. The set-top box defined in claim 142, wherein said first interface comprises a cable link.

145. A system, comprising the set-top box defined in claim 90 and said telephony device.

146. The system defined in claim 145, wherein said telephony device is connected to a telephone line, said telephony device being reachable by dialing a telephone number associated with the telephone line.

147. The system defined in claim 145, wherein said telephony device is connected to a data network and has an address within the data network, said telephony device being reachable by dialing a telephone number associated with said address of said telephony device.

148. The system defined in claim 145, wherein said telephony device has an electronic serial number, said telephony device being reachable by dialing a telephone number associated with the electronic serial number.

149. The set-top box defined in claim 90, wherein the information element comprises at least one of a commercial advertisement for a product or service; a product or service placement embedded in one of a television show and a motion picture; a solicitation for a charitable contribution; a public service announcement; an announcement made by a fan club; a survey; a poll; a vote; and an announcement for one of a call-in talk show and a debate.

150. The set-top box defined in claim 90, wherein said communication with an information source associated with the particular information element is established by virtue of joining the user to another telephone call previously answered by the information source.

151. The set-top box defined in claim 90, wherein said telephone call is a first telephone call, and wherein said communication with an information source associated with the particular information element is established by virtue of the information source answering a second telephone call placed not before placement of the first telephone call.

152. A method for execution at a set-top box registered to a television service subscriber, comprising:
receiving from a content provider a content stream conveying at least one information element deemed to be of potential interest to a multi-subscriber audience that includes the television service subscriber;
receiving a selection by the television service subscriber of a particular one of the at least one information element;
effecting a transmission to the content provider of an indication of said selection, said transmission being instrumental in causing a telephone call to be placed to a telephony device;
wherein when the telephone call is answered by a user of the telephony device, the user is placed in communication with an information source associated with the particular information element.
